(19) United States
(12) Patent Application Publication
(10) Pub. No.: US 2006/0127728 A1
(43) Pub. Date: Jun. 15, 2006

(54) Membrane-electrode assembly for fuel cell

(75) Inventors: Toshihiro Otsuki, Tokyo (JP); Nagayuki Kanaoka, Wako-shi (JP); Masaru Iguchi, Wako-shi (JP); Hiroshi Soma, Wako-shi (JP)

Correspondence Address: ARENT FOX PLLC, 1050 CONNECTICUT AVENUE, N.W., SUITE 400, WASHINGTON, DC, 20036, US

(73) Assignees: JSR CORPORATION; and; HONDA MOTOR CO., LTD

(21) Appl. No.: 11/302,346

(22) Filed: Dec. 14, 2005

(30) Foreign Application Priority Data
Dec. 15, 2004 (JP) 2004-362663
Dec. 15, 2004 (JP) 2004-362664

(51) Int. Cl. H01M 8/10

(52) U.S. Cl. 429/33

(57) ABSTRACT

The present invention provides a membrane-electrode assembly for fuel cell which comprises a solid polymer electrolyte membrane comprising a specific polyarylene having a sulfonic acid group and has excellent creep resistance, power generation performance and durability against power generation under high-temperature environment. The membrane-electrode assembly is characterized in that a pair of electrodes each comprising a gas diffusing layer and a catalyst layer are joined to both sides of a solid polymer electrolyte membrane so that the catalyst layer side comes into contact with the membrane, said membrane comprises a sulfonated polyarylene comprising constituent unit represented by the following formula (1): 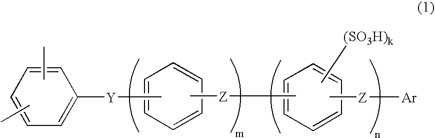
wherein Y is a group represented by —C(CF₃)₂—, (CF₂)ᵢ—, wherein i is an integer of 1 to 10, —SO— or —SO₂—; Z is a divalent electron-donating group or a direct bond; Ar is an aromatic group having a substituent represented by —SO₃H; m is an integer of 0 to 10; n is an integer of 0 to 10; and k is an integer of 1 to 4.

### FIELD OF THE INVENTION

The present invention relates to a membrane-electrode assembly for fuel cell and more particularly to a membrane-electrode assembly in solid polymer fuel cell using a solid polymer electrolyte membrane formed of a polyarylene having specific structure containing sulfonic acid group.

### BACKGROUND OF THE INVENTION

A solid polymer fuel cell comprises a membrane-electrode assembly which basically comprises two catalyst electrodes and a solid polymer electrolyte membrane held between the electrodes. Hydrogen as a fuel is ionized by one of the electrodes, and the hydrogen ions are diffused into the solid polymer electrolyte membrane and then combine with oxygen in the other electrode. In this case, when the two electrodes are connected to an external circuit, a current flows, and electric power is supplied to the external circuit. The solid polymer electrolyte membrane functions to diffuse hydrogen ions. At the same time, the solid polymer electrolyte membrane physically separates hydrogen and oxygen, in the fuel gas, from each other and cuts off the flow of electrons.

Fluorinated electrolyte membranes typified by perfluorocarbon sulfonic acid membranes proposed, for example, by Du Pont Ltd., Dow Ltd., Asahi Chemical Industry Co., Ltd., and Asahi Glass Co., Ltd. may be mentioned as the solid polymer electrolyte membrane. These fluorinated electrolyte membranes are highly chemically stable and thus have been used as electrolyte membranes for fuel cell and water splitting used under severe conditions.

The membrane-electrode assembly comprising a polymer electrolyte membrane formed of a perfluorocarbon sulfonic acid polymer compound, however, suffers from a problem that, due to its low glass transition temperature, when a fuel cell is constructed by the membrane-electrode assembly, a creep phenomenon occurs upon operation of the fuel cell at elevated temperatures.

Accordingly, electrolyte membranes such as fluorinated electrolyte membranes are disadvantageous in that applications of electrolyte membranes are limited to special applications such as space or military solid polymer fuel cell and, when they are applied, for example, to low-pollution power sources for automobiles, consumer small dispersed power sources, and portable power sources, the system becomes complicated because a process should be carried out in which a reformed gas composed mainly of hydrogen gas is produced from a low-molecular hydrocarbon as raw fuel and is then cooled and treated for removing carbon monoxide in the reformed gas.

Further, for fuel cell, the higher the operation temperature, the higher the activity of the electrode catalyst. In this case, the overvoltage of the electrode is lowered, and the level of poisoning by carbon monoxide in the electrode is reduced, leading to a demand for the development of a membrane-electrode assembly for solid polymer fuel cell which can generate electric power under elevated temperatures.

An object of the present invention is to provide a membrane-electrode assembly for fuel cell that comprises a solid polymer electrolyte membrane formed of a polyarylene having specific structure containing a sulfonic acid group and possesses excellent creep resistance, power generation performance and durability against power generation under high-temperature environment.

### SUMMARY OF THE INVENTION

A membrane-electrode assembly for fuel cell according to the present invention is characterized in that a pair of electrodes each comprising a gas diffusing layer and a catalyst layer are joined respectively to both sides of a solid polymer electrolyte membrane so that the catalyst layer side comes into contact with the solid polymer electrolyte membrane, said solid polymer electrolyte membrane comprises a sulfonated polyarylene comprising constituent unit represented by the following formula (1): 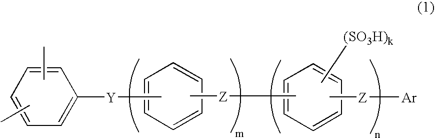
wherein Y is a group represented by —C(CF₃)₂—, —(CF₂)ᵢ—, wherein i is an integer of 1 to 10, —SO— or —SO₂—; Z is a divalent electron-donating group or a direct bond; Ar is an aromatic group having a substituent represented by —SO₃H; m is an integer of 0 to 10; n is an integer of 0 to 10; and k is an integer of 1 to 4.

Preferably, the sulfonated polyarylene comprises constituent unit represented by the formula (1) and constituent unit represented by the following formula (2) or formula (3): 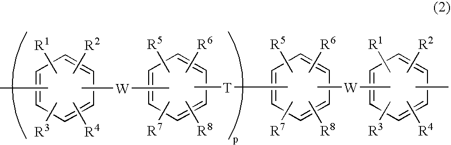
wherein R¹ to R⁸, which may be the same or different, are at least one atom or group selected from the group consisting of a hydrogen atom, a fluorine atom, an alkyl group, a fluorine-substituted alkyl group, an allyl group, an aryl group and a cyano group; W is a divalent electron withdrawing group or a direct bond; T is a divalent organic group or a direct bond; and p is 0 or a positive integer; and 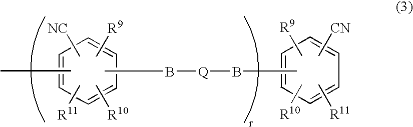
wherein B is independently an oxygen atom or a sulfur atom, R⁹ to R¹¹, which may be the same or different, are a hydrogen atom, a fluorine atom, a nitrile group or an alkyl group; r is 0 or a positive integer; and Q is a structure represented by the following formula (q): 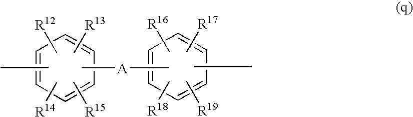
wherein A is a divalent atom, a divalent organic group or a direct bond; R¹² to R¹⁹, which may be the same or different, are a hydrogen atom, a fluorine atom, an alkyl group or an aromatic group.

The use of the membrane-electrode assembly according to the present invention can provide a solid polymer fuel cell possessing excellent creep resistance, power generation performance and durability against power generation under high-temperature environment.

### DETAILED DESCRIPTION OF THE INVENTION

The membrane-electrode assembly for fuel cell according to the present invention will be described in detail.

In the membrane-electrode assembly for fuel cell according to the present invention (hereinafter often referred to simply as “MEA”), a pair of electrodes each comprising a gas diffusing layer and a catalyst layer are joined respectively to both sides of a solid polymer electrolyte membrane so that the catalyst layer side comes into contact with the solid polymer electrolyte membrane, and the solid polymer electrolyte membrane comprises a polyarylene having a specific structure containing sulfonic acid group (hereinafter often referred to simply as “sulfonated polyarylene”).

[Sulfonated Polyarylene]

The sulfonated polyarylene used in the present invention comprises constituent unit represented by the formula (1) (hereinafter often referred to as “unit (1)”) and preferably further comprises constituent unit represented by the formula (2) (hereinafter often referred to as “unit (2)”) or constituent unit represented by the formula (3) (hereinafter often referred to as “unit (3)”).

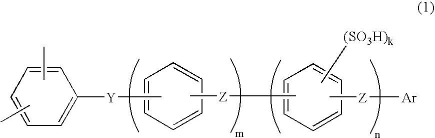

In the formula (1), Y represents a group represented by —C(CF₃)₂—, —(CF₂)ᵢ—, wherein i is an integer of 1 to 10, —SO— or —SO₂—. When Y is this group, an electrolyte having excellent chemical stability can be provided and, thus, excellent power generation performance and durability against power generation can be realized.

Z represents a divalent electron-donating group or a direct bond, and example thereof include —O—, —S—, —C(CH₃)₂—, —(CH₂)ⱼ, wherein j is an integer of 1 to 10, —CH═CH—, —C≡C— and a group represented by the following chemical formula: 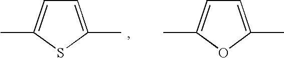
Among them, a group represented by —O— or —S— is preferred.

Ar represents an aromatic group having a substituent represented by —SO₃H. Examples thereof include phenyl, naphthyl, anthryl and phenanthryl groups. Among them, phenyl and naphthyl groups are preferred.

m is an integer of 0 to 10, preferably 0 to 2; n is an integer of 0 to 10, preferably 0 to 2, and k is an integer of 1 to 4.

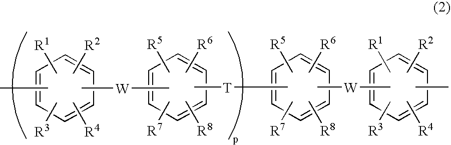

In the formula (2), R¹ to R⁸, which may be the same or different, represent at least one atom or group selected from the group consisting of a hydrogen atom, a fluorine atom, an alkyl group, a fluorine-substituted alkyl group, an allyl group, an aryl group and a cyano group.

The alkyl groups include methyl, ethyl, propyl, butyl, amyl and hexyl groups. Preferred are methyl and ethyl groups.

The fluorine-substituted alkyl groups include trifluoromethyl, perfluoroethyl, perfluoropropyl, perfluorobutyl, perfluoropentyl and perfluorohexyl groups. Preferred are trifluoromethyl and perfluoroethyl groups.

The allyl groups include a propenyl group.

The aryl groups include phenyl and pentafluorophenyl groups.

W represents a divalent electron-withdrawing group or a direct bond. Such divalent electron-withdrawing groups include, for example, —C(CF₃)₂—, —(CF₂)ᵢ—, wherein i is an integer of 1 to 10, —CO—, —CONH—, —COO—, —SO— and —SO₂—.

T represents a divalent organic group or a direct bond. The divalent organic group is not particularly limited, and examples thereof include electron-withdrawing groups as described in W, electron-donating groups as described in Z, and organic groups as described in A in formula (q) below.

p is 0 or a positive integer, and the upper limit of p is generally 100, preferably 10 to 80.

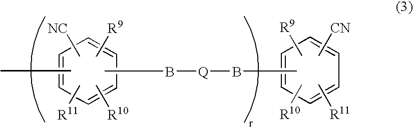

In the formula (3), R⁹ to R¹¹, which may be the same or different, represent a hydrogen atom, a fluorine atom, a nitrile group or an alkyl group. Examples of the alkyl groups include methyl, ethyl, propyl, butyl, amyl and hexyl groups. Preferred are methyl and ethyl groups.

B independently represents an oxygen or sulfur atom. r is 0 or a positive integer, and the upper limit of r is generally 100, preferably 80. r is preferably 2 or more.

Q represents a structure represented by the following formula (q).

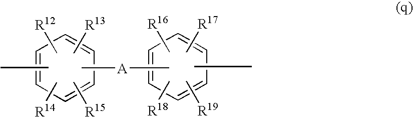

In the formula (q), R¹² to R¹⁹, which may be the same or different, represent a hydrogen atom, a fluorine atom, an alkyl group or an aromatic group. Examples of the alkyl groups include methyl, ethyl, propyl, butyl, amyl and hexyl groups. Preferred are methyl and ethyl groups. Examples of the aromatic groups include phenyl, naphthyl, pyridyl, phenoxydiphenyl, phenylphenyl and a naphthoxyphenyl groups.

A independently represents a divalent atom, a divalent organic group or a direct bond. Examples of the divalent organic groups include electron-withdrawing groups such as —C(CF₃)₂— or —(CF₂)ᵢ—, wherein i is an integer of 1 to 10, —CO—, —CONH—, —COO—, —SO— and —SO₂—, and electron-donating groups such as —O—, —S—, —C(CH₃)₂—, —(CH₂)ⱼ—, wherein j is an integer of 1 to 10, —CH═CH—, —C≡C— and groups represented by the following formulae.

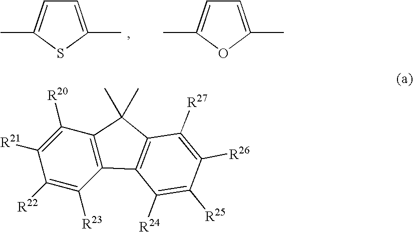

In the formula (a), R²⁰ to R²⁷, which may be the same or different, represent a hydrogen atom, a fluorine atom, an alkyl group or an aromatic group. Examples of alkyl and aromatic groups include those as described above in R¹² to R₁₉.

Preferably, A represents a direct bond or an organic group selected from —C(CF₃)₂—, —(CF₂)ᵢ—, —CO—, —CONH—, —COO—, —SO—, —SO₂—, —C(CH₃)₂— and groups represented by formula (a).

In the unit (3), the structure Q may comprise both a structure (Q1) in which A is selected from —C(CF₃)₂—, —(CF₂)ᵢ—, —CO—, —CONH—, —COO—, —SO—, —SO₂— and —C(CH₃)₂—, and a structure (Q2) in which A is a direct bond or a group represented by formula (a).

In particular, when the content of the structure (Q1) is 99 to 20% by mole, preferably 95 to 30% by mole, particularly preferably 90 to 35% by mole, and the content of the structure (Q2) is 1 to 80% by mole, preferably 5 to 70% by mole, particularly preferably 10 to 65% by mole, the total of Q1 and Q2 being 100% by mole, the percentage dimensional change of the resultant polymer can be reduced to a lower level.

Preferably, the sulfonated polyarylene comprises 0.5 to 100% by mole, more preferably 10 to 99.999% by mole, particularly preferably 20 to 99.9% by mole, of the unit (1) and 99.5 to 0% by mole, more preferably 90 to 0.001% by mole, particularly preferably 80 to 0.1% by mole, of the unit (2) or (3).

The sulfonated polyarylene can be synthesized by copolymerizing a sulfonic ester group-containing monomer which can constitute the unit (1) (hereinafter often referred to as “monomer (1′)”) with a monomer which can constitute the unit (2) (including an oligomer; hereinafter often referred to as “monomer (2′)”) or a monomer which can constitute the unit (3) (including an oligomer; hereinafter often referred to as “monomer (3′)”) to synthesize a sulfonic ester group-containing polyarylene and then hydrolyzing this sulfonic ester group-containing polyarylene to convert the sulfonic ester group to a sulfonic group.

Alternatively, the sulfonated polyarylene may also be synthesized by previously synthesizing a polyarylene (nonsulfonated polyarylene) comprising the same constituent units as represented by general formula (1) except for the absence of both the sulfonic acid group and the sulfonic ester group and the unit (2) or (3), and then sulfonating the nonsulfonated polyarylene.

Examples of the monomer (1′) which can constitute the unit (1) include sulfonic esters represented by general formula (1′).

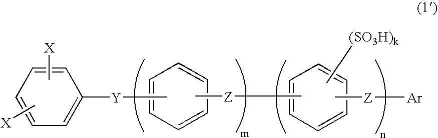

In the formula (1′), X represents an atom or a group selected from halogen atoms excluding fluorine (i.e., chlorine, bromine and iodine) and —OSO₂G wherein G represents an alkyl group or a fluorine-substituted alkyl or aryl group; and Y, Z, m, n and k as defined above in the formula (1).

R^{a} represents a hydrocarbon group having 1 to 20, preferably 4 to 20 carbon atoms, and examples thereof include straight chain hydrocarbon groups, branched hydrocarbon groups, alicyclic hydrocarbon groups and five-membered heterocyclic ring-containing hydrocarbon groups, such as methyl, ethyl, n-propyl, iso-propyl, tert-butyl, iso-butyl, n-butyl, sec-butyl, neopentyl, cyclopentyl, hexyl, cyclohexyl, cyclopentylmethyl, cyclohexylmethyl, adamantyl, adamantanemethyl, 2-ethylhexyl, bicyclo[2.2.1]heptyl, bicyclo[2.2.1]heptylmethyl, tetrahydrofurfuryl, 2-methylbutyl, 3,3-dimethyl-2,4-dioxolanemethyl, cyclohexylmethyl and adamantylmethyl groups. Among them, n-butyl, neopentyl, tetrahydrofurfuryl, cyclopentyl, cyclohexyl, cyclohexylmethyl, adamantylmethyl and bicyclo[2.2.1]heptylmethyl groups are preferred, and a neopentyl group is particularly preferred.

Ar represents an aromatic group containing a substituent represented by —SO₃R^{b}. The aromatic groups include phenyl, naphthyl, anthryl and phenanthryl groups. Among them, phenyl and naphthyl groups are preferred.

One or at least two substituents —SO₃R^{b} are present on the aromatic group. When two or more substituents —SO₃R^{b} are present, these substituents may be the same or different.

R^{b} represents a hydrocarbon group having 1 to 20, preferably 4 to 20 carbon atoms, and specific examples thereof include the hydrocarbon groups having 1 to 20 carbon atoms as described above. Among them, n-butyl, neopentyl, tetrahydrofurfuryl, cyclopentyl, cyclohexyl, cyclohexylmethyl, adamantylmethyl and bicyclo[2.2.1]heptylmethyl groups are preferred, and a neopentyl group is particularly preferred.

Examples of the monomer (1′) include compounds listed below.

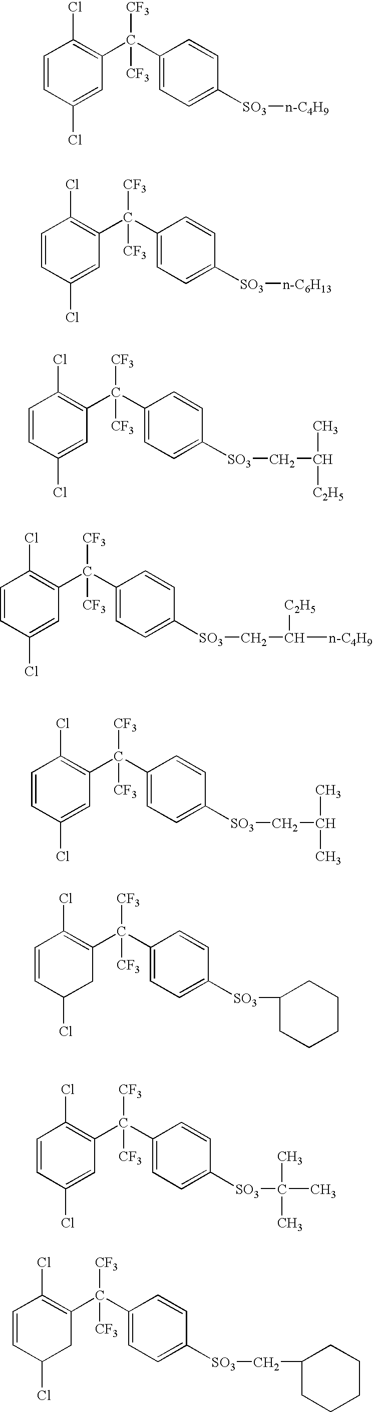

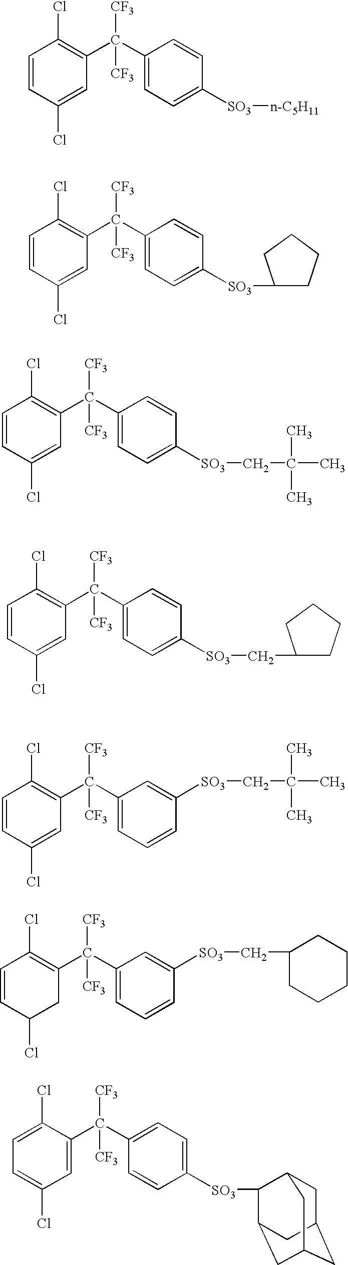

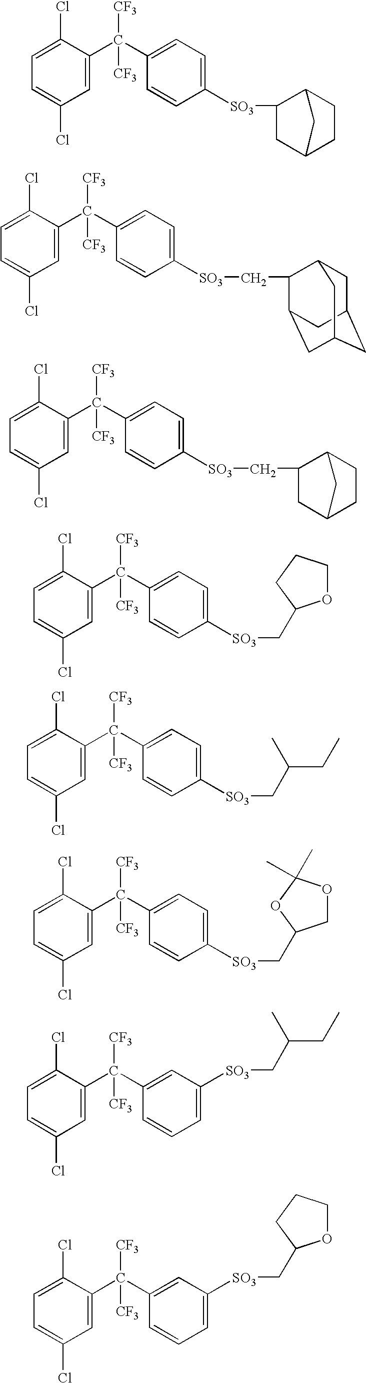

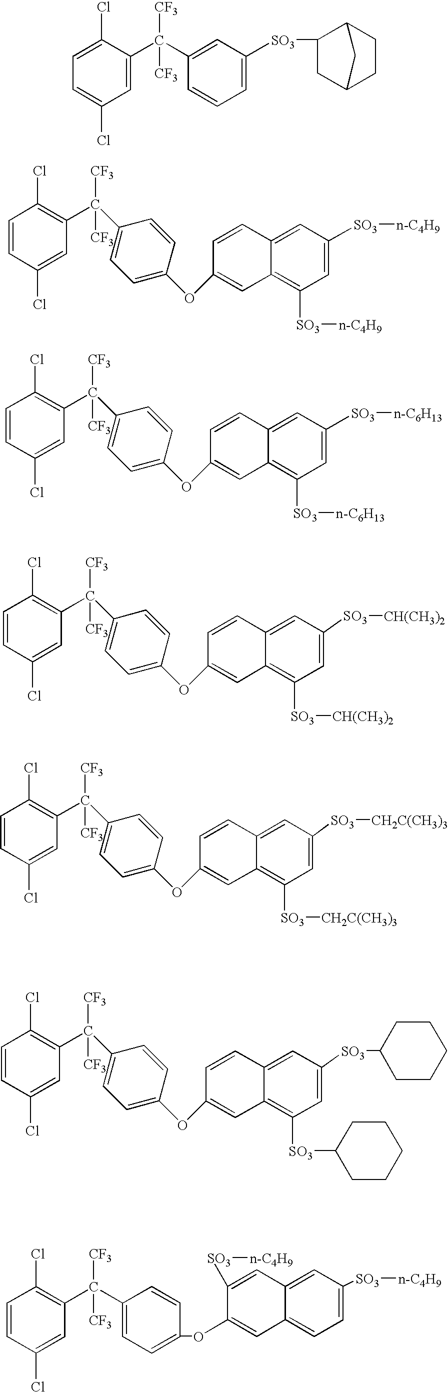

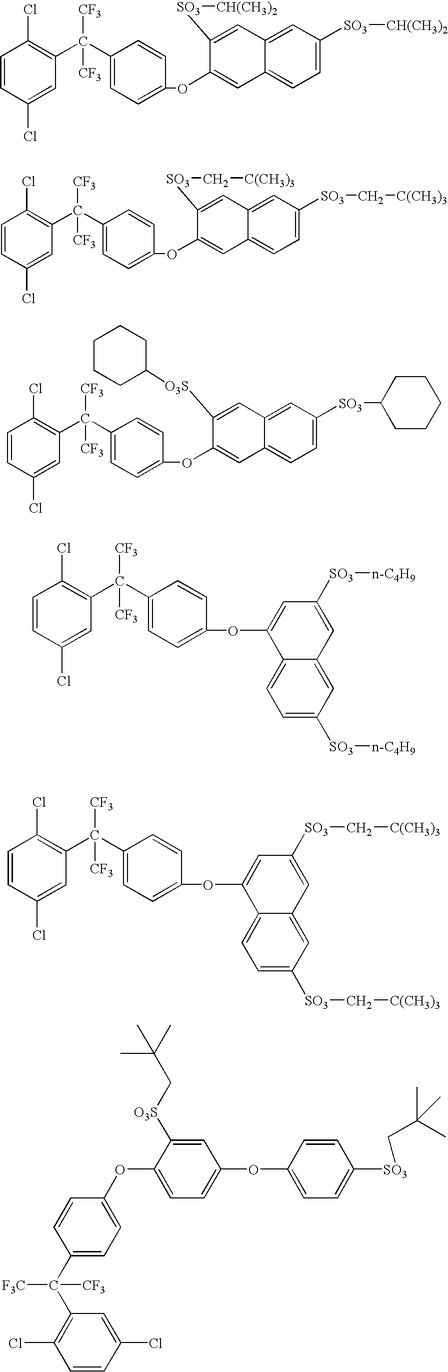

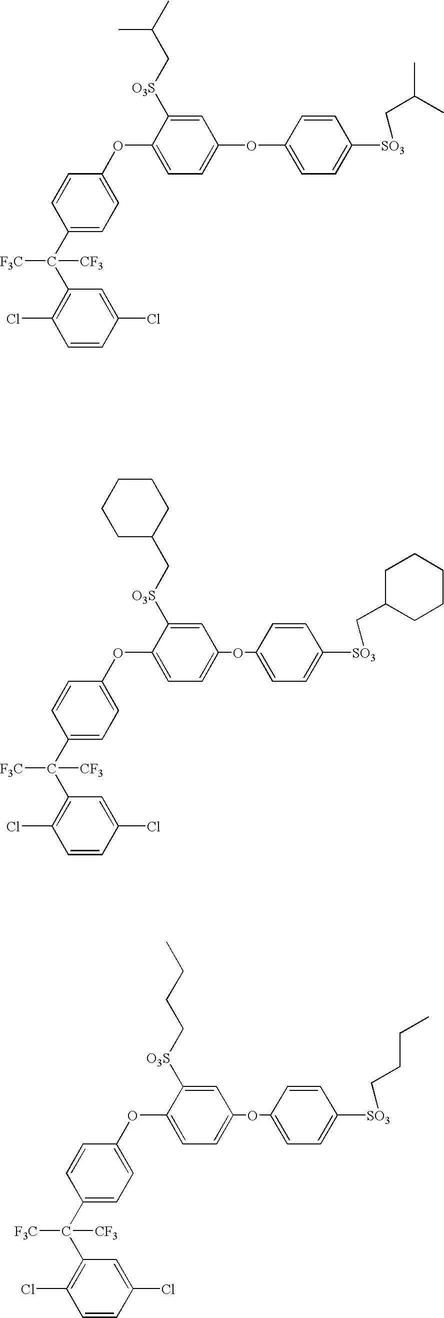

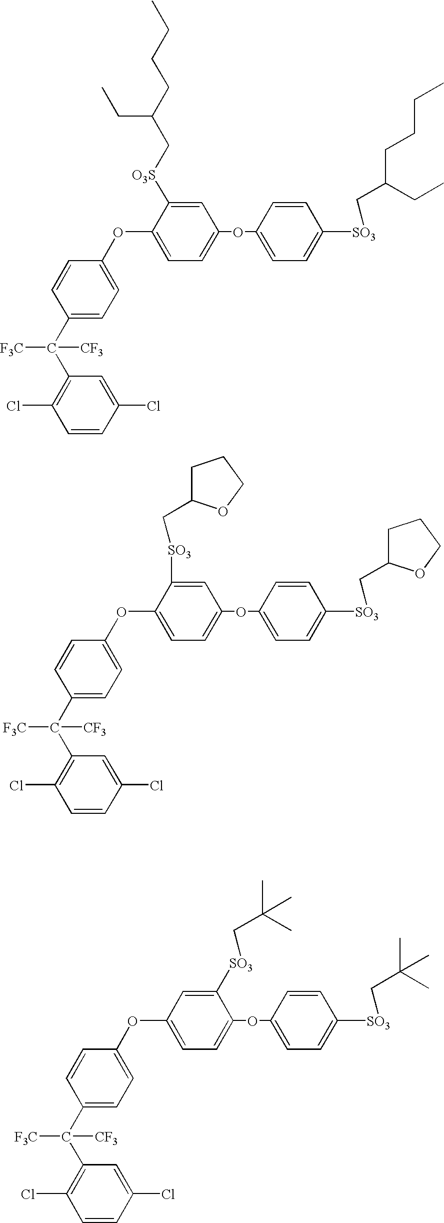

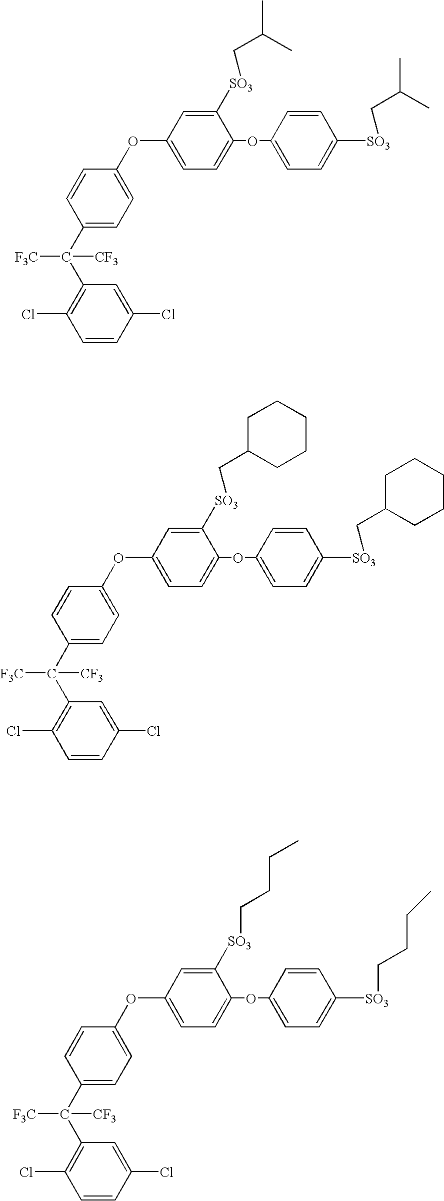

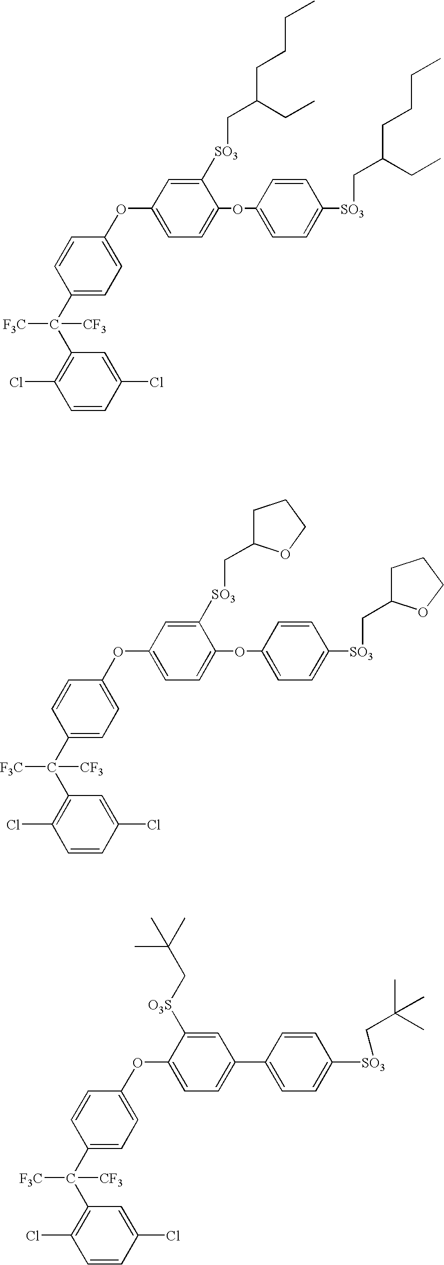

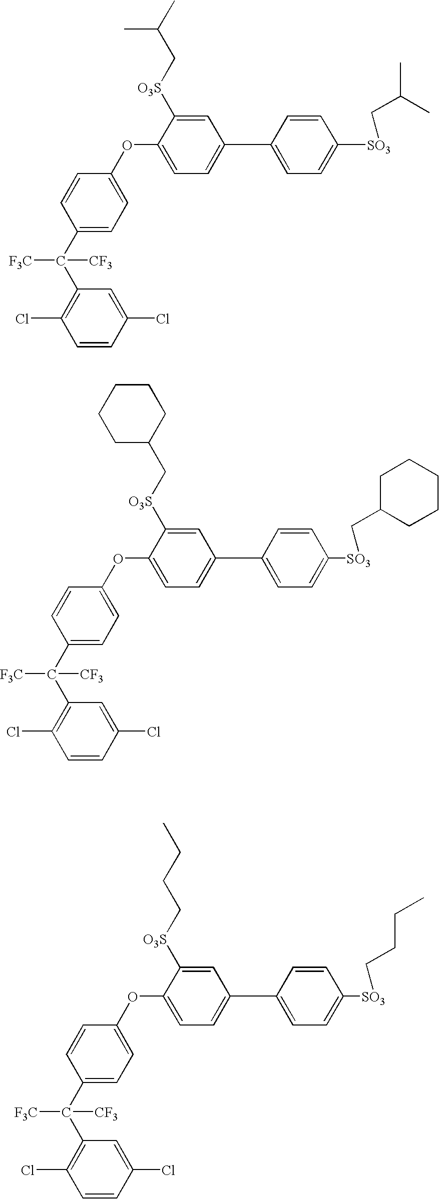

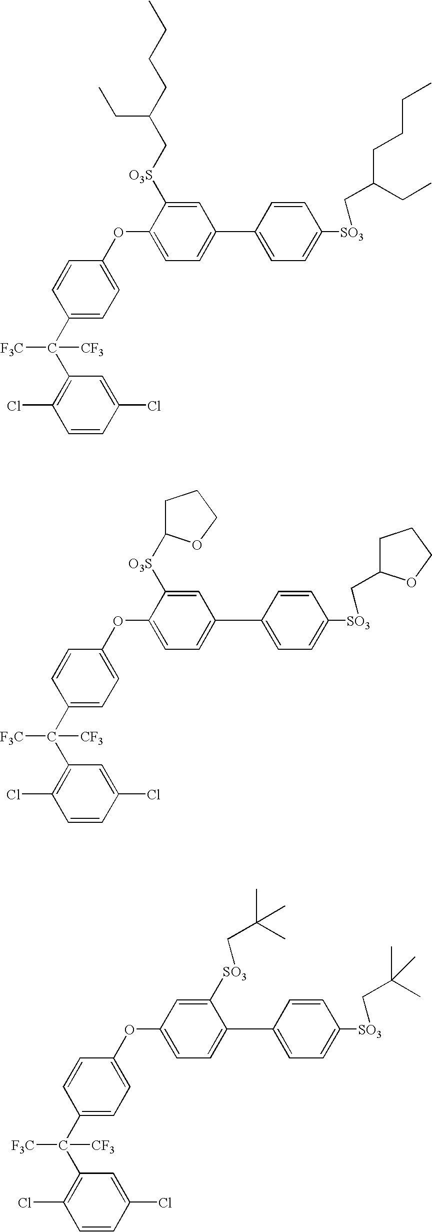

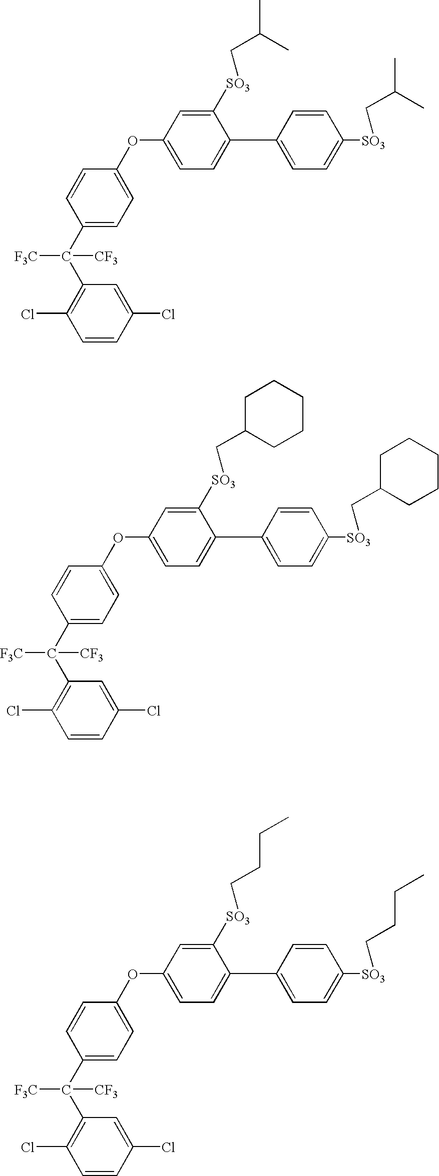

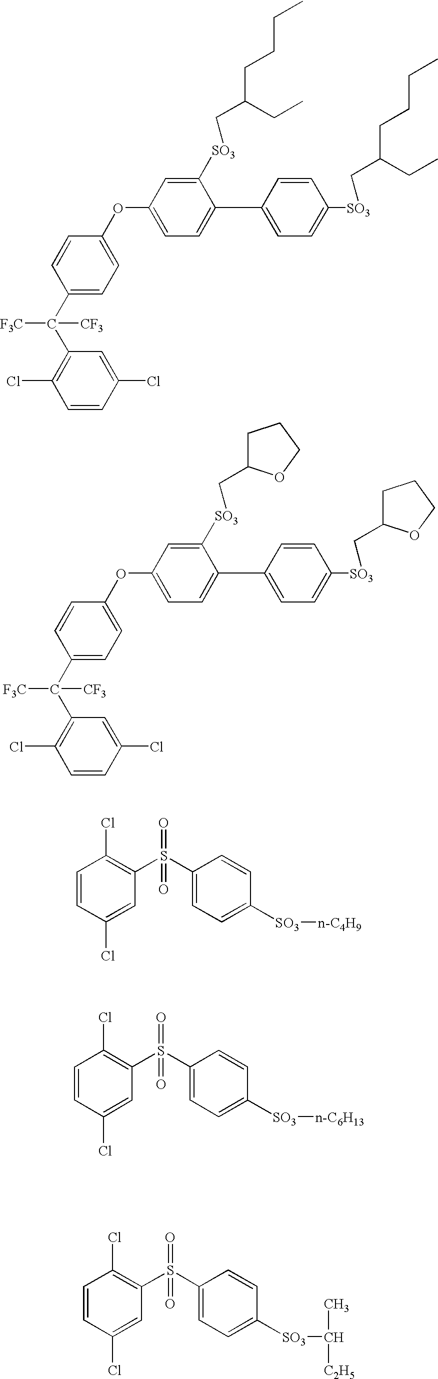

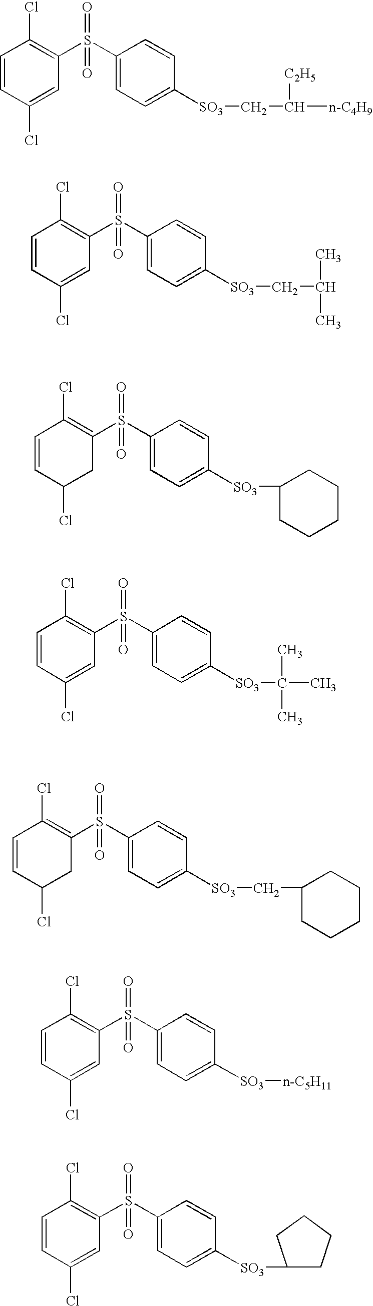

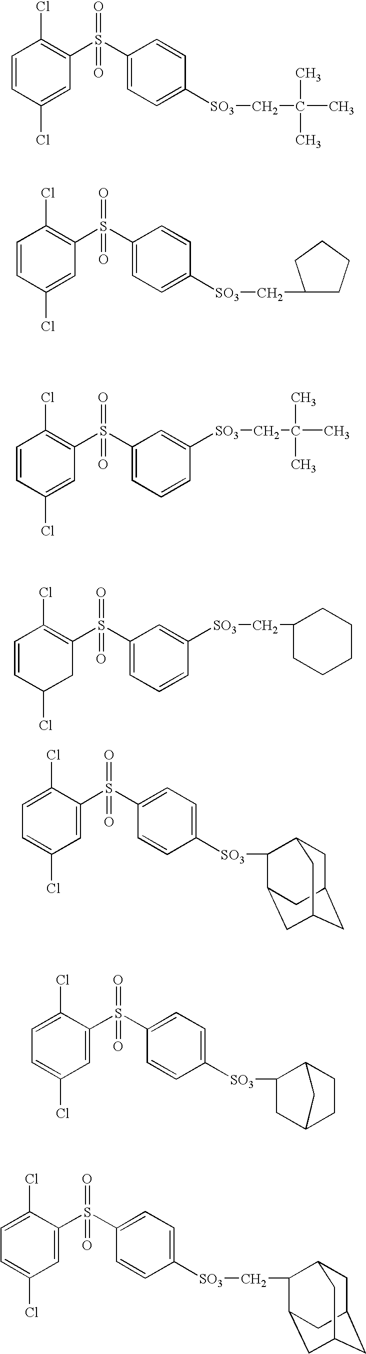

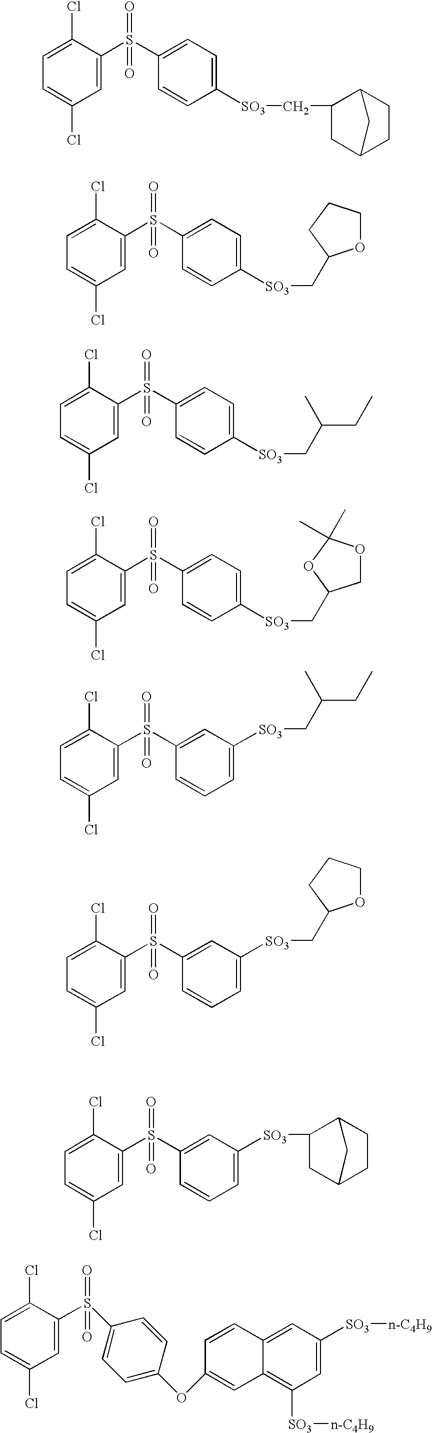

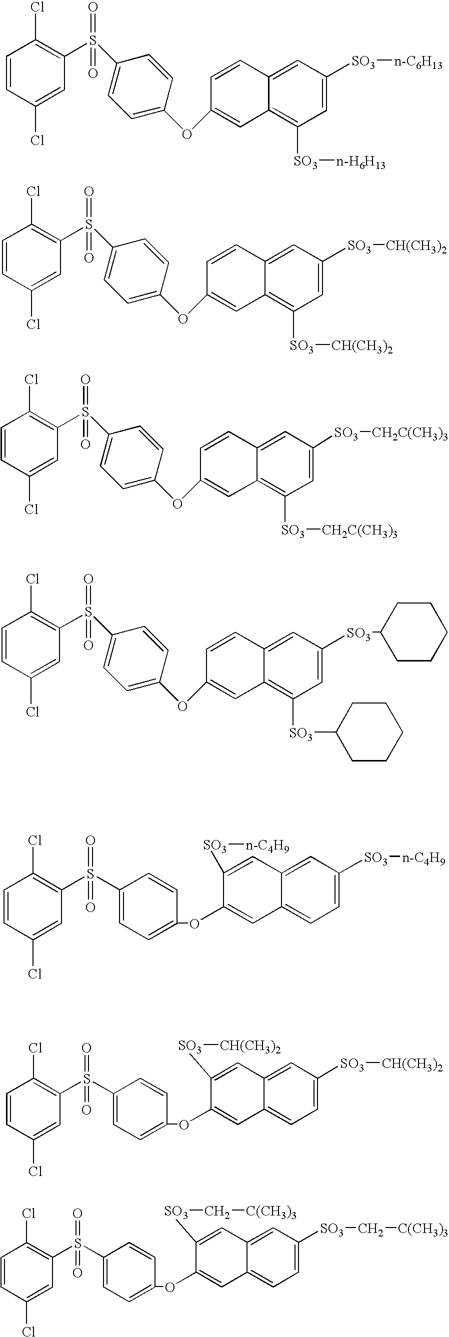

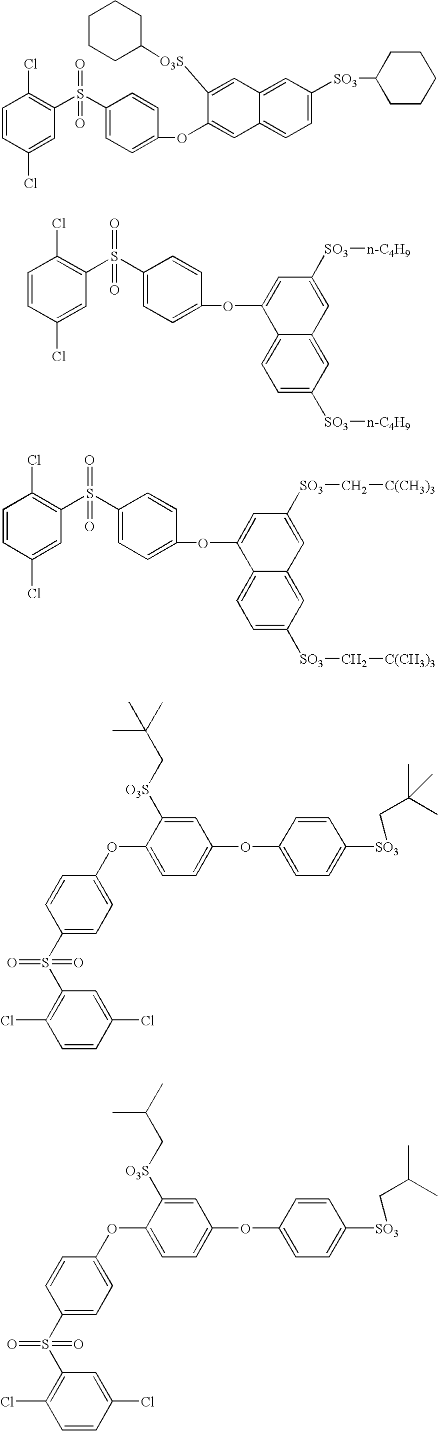

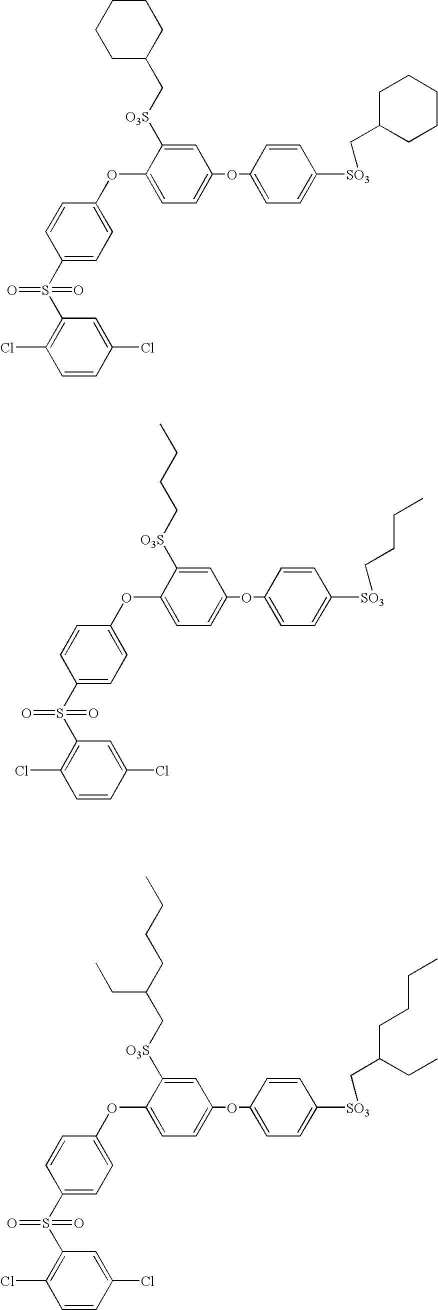

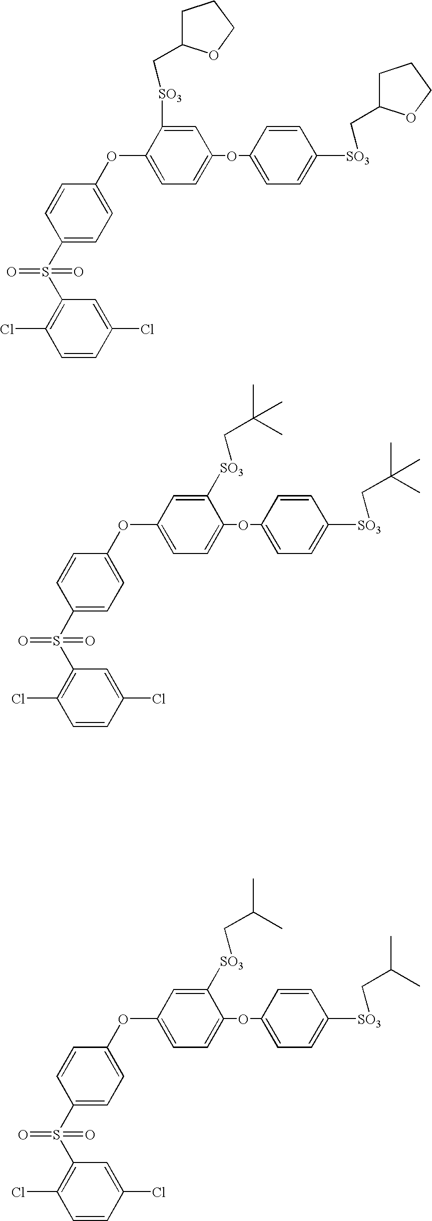

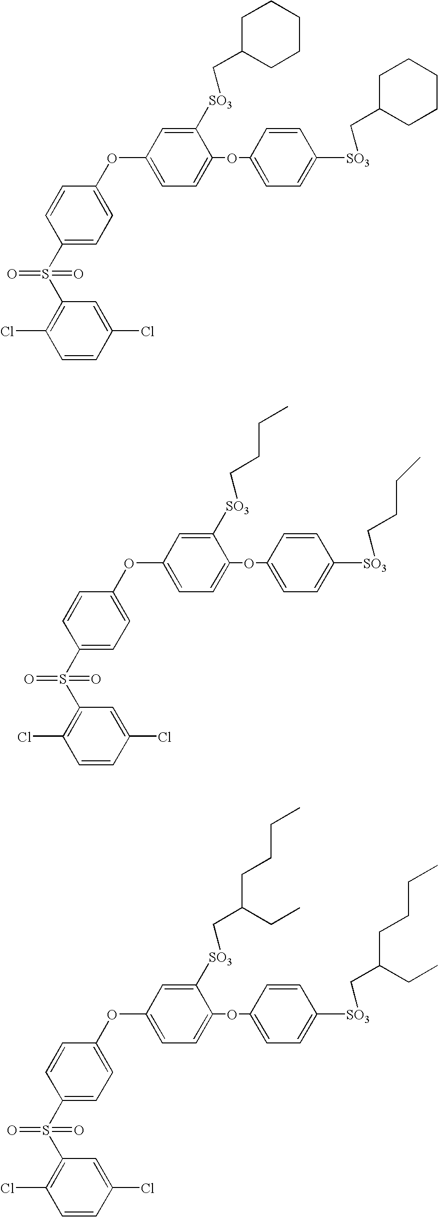

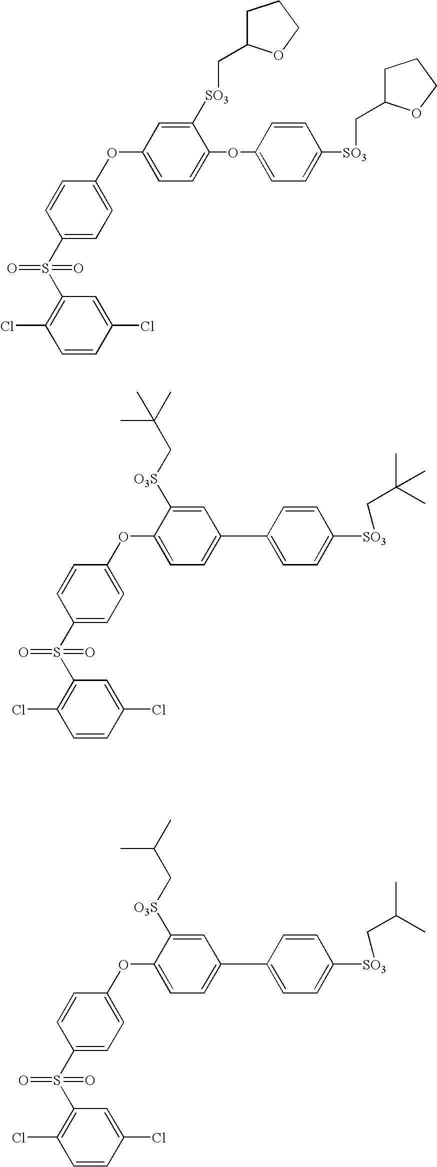

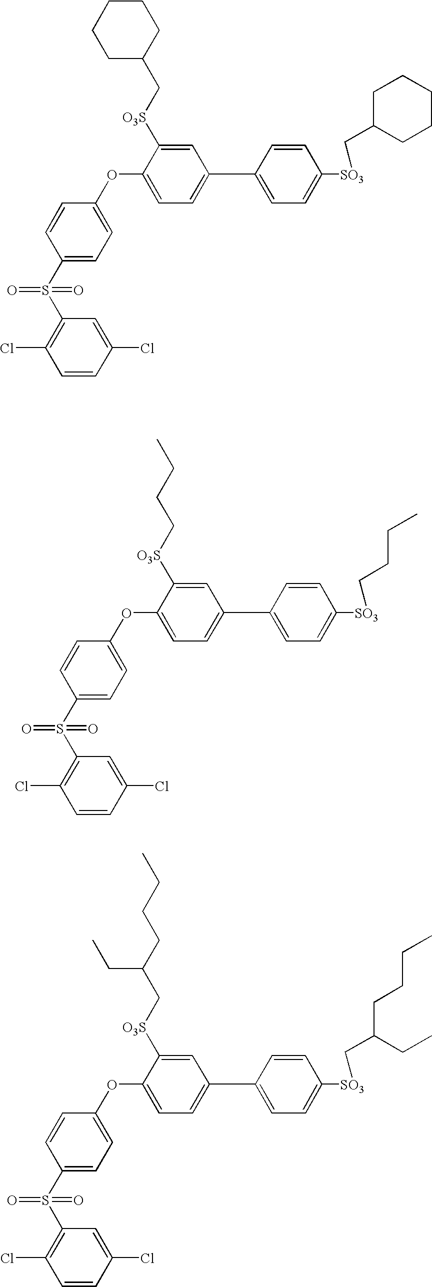

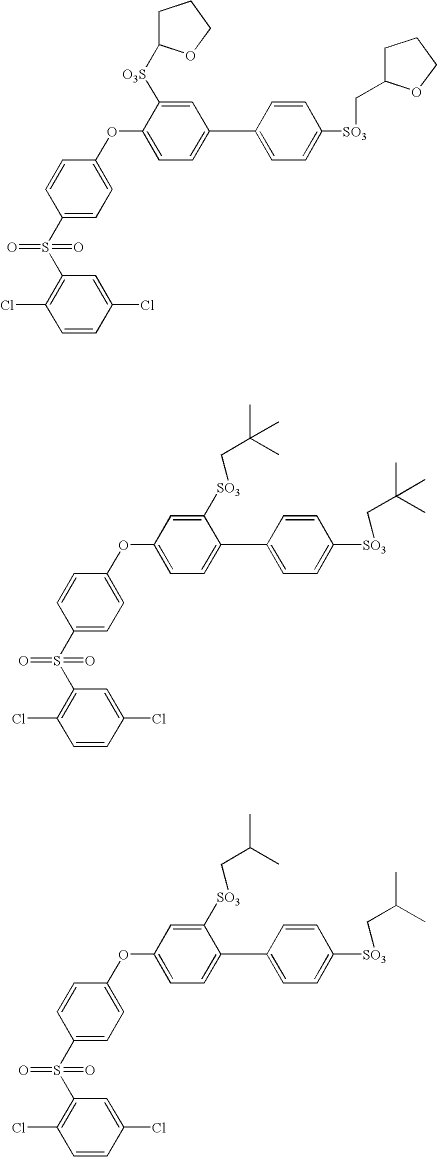

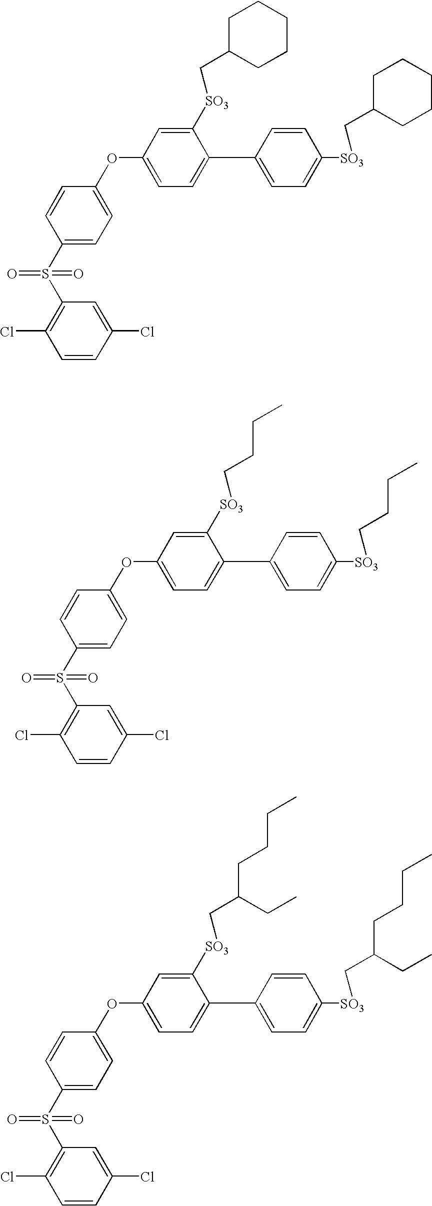

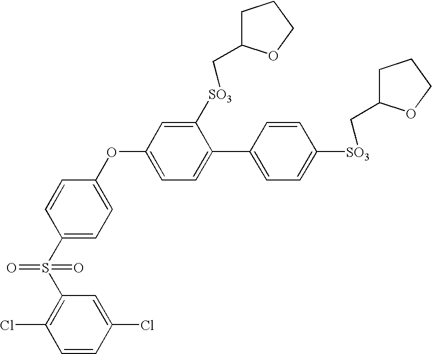

Compounds in which, in the above compounds, —C(CF₃)₂— was replaced with —(CF₂)ᵢ—, and compounds in which —SO₂— was replaced with —SO— may also be mentioned.

Group R^{b} in the formula (1′) is preferably such that this group is derived from a primary alcohol and β carbon is tertiary or quaternary carbon and more preferably such that this group is derived from a primary alcohol and the β-position is quaternary carbon. In this case, stability during the step of polymerization is excellent and, at the same time, polymerization inhibitor and crosslinking attributable to the production of sulfonic acid by deesterification are less likely to take place.

Examples of the compounds containing neither a sulfonic acid group nor a sulfonic ester group in the formula (1′) include the following compounds.

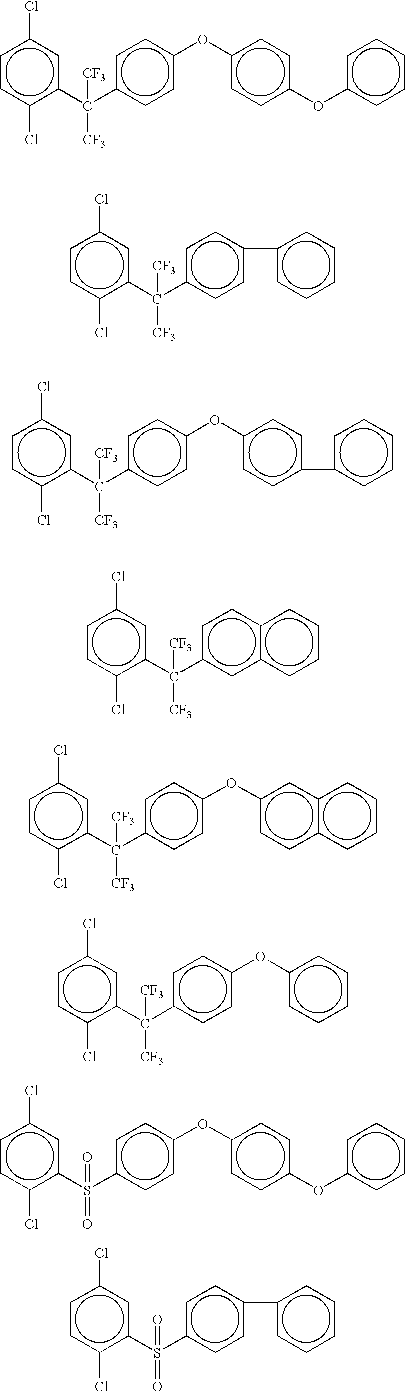

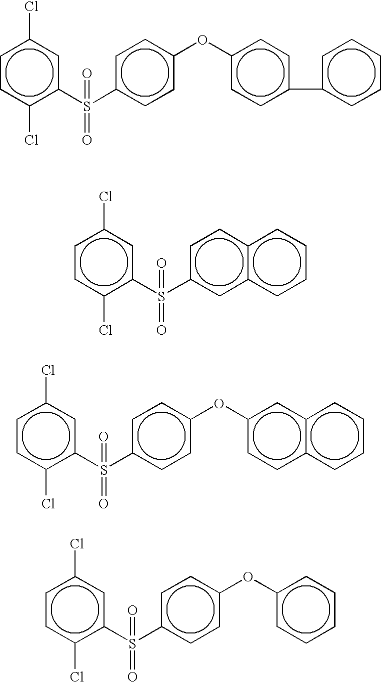

Compounds in which, in the above compounds, —C(CF₃)₂— was replaced with —(CF₂)ᵢ—, and compounds in which —SO₂— was replaced with —SO— may also be mentioned.

Example of the monomer (2′) (including oligomer) which can constitute the unit (2) include compounds represented by the following formula (2′).

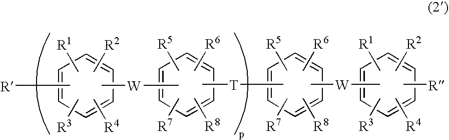

In the formula (2′), R′ and R″, which may be the same or different, represent a halogen atom except for a fluorine atom or a group represented by —OSO₂G wherein G represents an alkyl, fluorine-substituted alkyl or aryl group; and R¹ to R⁸, W, T and p have respectively the same meanings as R¹ to R⁸, W, T and p in the formula (2). Examples of the alkyl groups represented by G include methyl and ethyl groups, examples of the fluorine-substituted alkyl groups represented by G include a trifluoromethyl group, and examples of aryl groups represented by G include phenyl and p-tolyl groups.

In the case where p=0, examples of monomer (2′) include 4,4′-dichlorobenzophenone, 4,4′-dichlorobenzanilide, bis(chlorophenyl) difluoromethane, 2,2-bis(4-chlorophenyl)hexafluoropropane, 4-chlorobenzoic acid-4-chlorophenyl, bis(4-chlorophenyl)sulfoxide and bis(4-chlorophenyl)sulfone. Compounds in which, in these compounds, the chlorine atom is replaced with a bromine or iodine atom, and compounds in which, in these compounds, one or more halogen atoms, which are present as the substituent at the 4-position, are present as the substituent at the 3-position may also be mentioned.

In the case where p=1, examples of monomer (2′) include 4,4′-bis(4-chlorobenzoyl)diphenyl ether, 4,4′-bis(4-chlorobenzoylamino)diphenyl ether, 4,4′-bis(4-chlorophenylsulfonyl)diphenyl ether, 4,4′-bis(4-chlorophenyl)diphenyl ether dicarboxylate, 4,4′-bis[(4-chlorophenyl)-1,1,1,3,3,3-hexafluoropropyl]diphenyl ether and 4,4′-bis[(4-chlorophenyl)tetrafluoroethyl]diphenyl ether. Further, compounds in which, in these compounds, the chlorine atom is replaced with a bromine or iodine atom, compounds in which, in these compounds, the halogen atom, which is present as the substituent at the 4-position, is present as the substituent at the 3-position, and compounds in which, in these compounds, at least one of the groups present as the substituent at the 4-position or diphenyl ether is present as the substituent at the 3-position may also be mentioned.

Further examples of monomer (2′) include 2,2-bis[4-{4-(4-chlorobenzoyl)phenoxy}phenyl]-1,1,1,3,3,3-hexafluoropropane, bis[4-{4-(4-chlorobenzoyl)phenoxy}phenyl]sulfone and compounds represented by the following formula.

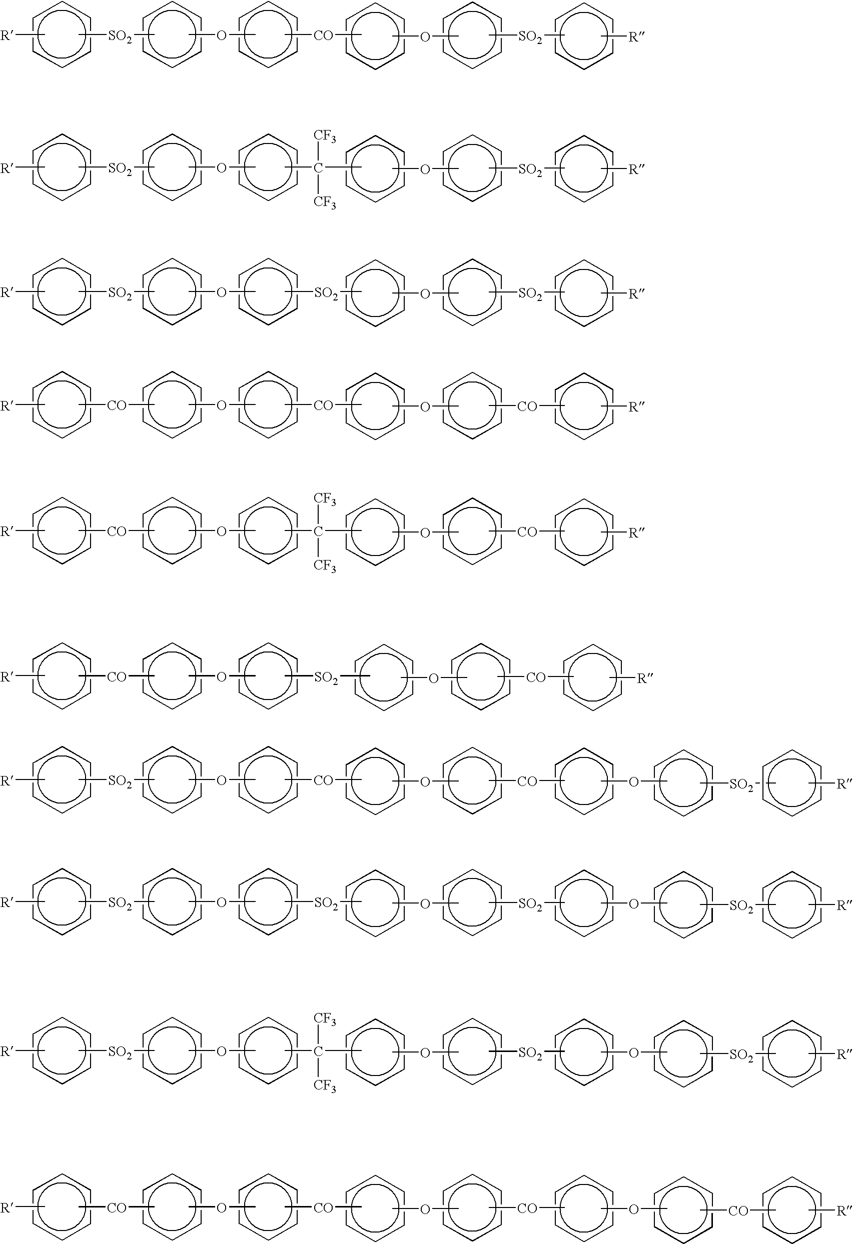

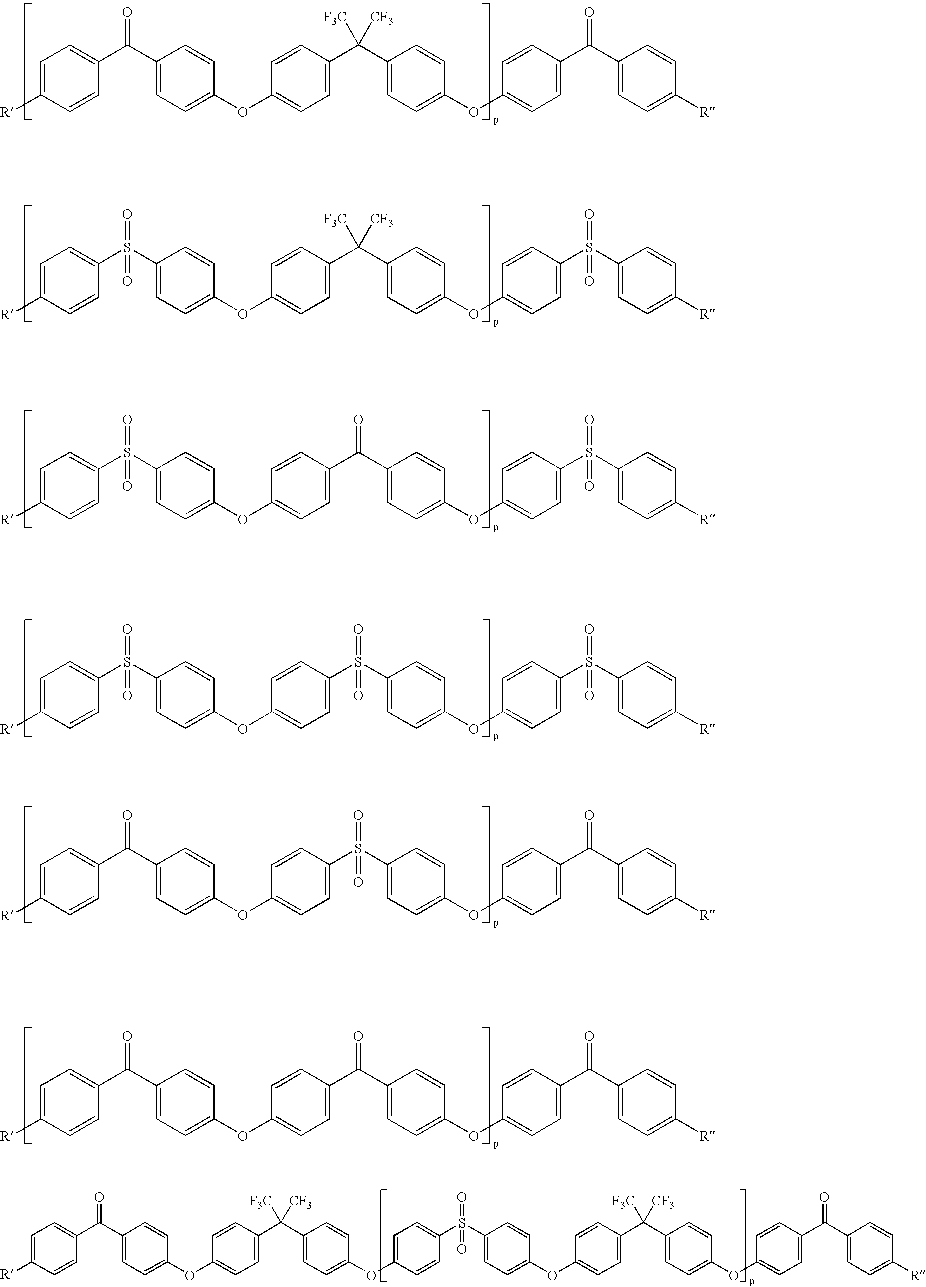

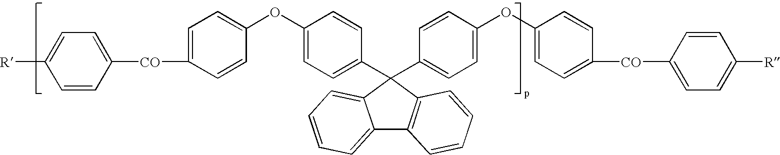

The monomer (2′) may be synthesized, for example, by the following method.

At the outset, in order to convert the bisphenol compound to the corresponding alkali metal salt of bisphenol, for example, an alkali metal such as lithium, sodium and potassium, an alkali metal hydride, an alkali metal hydroxide or an alkali metal carbonate is added in a polar solvent having high permittivity such as N-methyl-2-pyrrolidone, N,N-dimethylacetamide, sulfolane, diphenylsulfone and dimethyl sulfoxide. In the reaction, the amount of the alkali metal is somewhat excessive relative to the hydroxyl group in bisphenol and is generally 1.1 to 2 times, preferably 1.2 to 1.5 times, in terms of equivalent, the amount of the hydroxyl group in bisphenol.

Next, the alkali metal salt of bisphenol is reacted with an aromatic dihalide compound activated by an electron-withdrawing group (hereinafter often referred to as “active aromatic dihalide”) in a solvent which can be azeotroped with water, for example, benzene, toluene, xylene, hexane, cyclohexane, octane, chlorobenzene, dioxane, tetrahydrofuran, anisole or phenetole.

The active aromatic dihalide is used in an amount of 2 to 4 times by mole, preferably 2.2 to 2.8 times by mole, the amount of bisphenol. The reaction temperature is in the range of 60° C. to 300° C., preferably 80° C. to 250° C. The reaction time is 15 min to 100 hr, preferably one hr to 24 hr.

Active aromatic dihalides include, for example, 4,4′-difluorobenzophenon, 4,4′-dichlorobenzophenon, 4,4′-chlorofluorobenzophenon, bis(4-chlorophenyl)sulfone, bis(4-fluorophenyl)sulfone, 4-fluorophenyl-4′-chlorophenylsulfone, bis(3-nitro-4-chlorophenyl)sulfone, 2,6-dichlorobenzonitrile, 2,6-difluorobenzonitrile, hexafluorobenzene, decafluorobiphenyl, 2,5-difluorobenzophenone and 1,3-bis(4-chlorobenzoyl)benzene. When the reactivity is taken into consideration, these active aromatic dihalides are preferably fluorocompounds. When the following aromatic coupling reaction is taken into consideration, the reaction should be designed so that a monomer (2′) in which both ends are a chlorine atom is obtained.

For example, when a chlorofluoro compound, that is, an active aromatic dihalide in which two halogen atoms are different from each other in reactivity, is used as the active aromatic dihalide, the fluorine atoms preferentially causes a nucleophilic displacement reaction with phenoxide and, thus, a monomer (2′) in which both ends are a chlorine atom can be produced with high efficiency.

Alternatively, as described in Japanese Patent Laid-Open No. 159/1990, a contemplated monomer (2′) containing an electron-withdrawing group and an electron-donating group may be synthesized by a combination of a nucleophilic displacement reaction with an electrophilic displacement reaction. Specifically, at the outset, the active aromatic dihalide exemplified above, for example, bis(4-chlorophenyl)sulfone is subjected to a nucleophilic displacement reaction with a phenol compound to give a bisphenoxy compound. Next, a contemplated compound can be produced by a Friedel-Crafts reaction of the bisphenoxy compound with 4-chlorobenzoic acid chloride.

The phenol compound used in the reaction may be a substituted compound. However, an unsubstituted compound is preferred from the viewpoints of heat resistance and flexibility. In the substitution reaction with the active aromatic dihalide, the phenol compound is preferably an alkali metal salt. Alkali metal compounds usable herein include compounds exemplified above, and the alkali metal compound is used in an amount of 1.2 to 2 times by mole based on one mole of phenol. In the reaction, the above polar solvent or solvent which can be azeotroped with water may be used.

The chlorobenzoic acid chloride used in the Friedel-Crafts reaction is used in an amount of 2 to 4 times by mole, preferably 2.2 to 3 times by mole based on the bisphenoxy compound.

The Friedel-Crafts reaction is preferably carried out in the presence of a Friedel-Crafts activating agent such as aluminum chloride, boron trifluoride or zinc chloride. The Friedel-Crafts activating agent is used in an amount of 1.1 to 2 times in terms of equivalent based on one mole of the active halide compound such as chlorobenzoic acid. The reaction time is in the range of 15 min to 10 hr, and the reaction temperature is in the range of −20° C. to 80° C. Reaction solvents usable herein include solvents inert to the Friedel-Crafts reaction such as chlorobenzene or nitrobenzene.

The monomer (2′) represented by general formula (2′) in which p is 2 or more may be produced by subjecting an alkali metal salt of bisphenol and an excessive amount of an active aromatic dihalide to a displacement reaction according to the above synthetic method in the presence of a polar solvent such as N-methyl-2-pyrrolidone, N,N-dimethylacetamide or sulfolane. Examples of bisphenols usable in this case include 2,2-bis(4-hydroxyphenyl)-1,1,1,3,3,3-hexafluoropropane, 2,2-bis(4-hydroxyphenyl)ketone and 2,2-bis(4-hydroxyphenyl)sulfone. Examples of active aromatic dihalides usable herein include 4,4-dichlorobenzophenon and bis(4-chlorophenyl)sulfone.

Examples of the monomer (3′) (including oligomer) which can constitute the unit (3) include compounds represented by the following formula (3′).

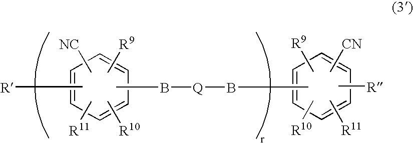

In the formula (3′), R′ and R″, which may be the same or different, represent a halogen atom except for a fluorine atom or a group represented by —OSO₂G wherein G represents an alkyl, fluorine-substituted alkyl or aryl group; and R⁹ to R¹¹, B, Q and r have respectively the same meanings as R⁹ to R¹¹, B, Q and r in the formula (3). Examples of the alkyl groups represented by G include methyl and ethyl groups, examples of the fluorine-substituted alkyl groups represented by G include a trifluoromethyl group, and examples of the aryl groups represented by G include phenyl and p-tolyl groups.

The monomer (3′) may be synthesized in the same manner as in the monomer (2′). Specifically, the monomer (3′) may be synthesized by the following reaction.

At the outset, a bisphenol connected through a divalent atom, a divalent organic group or a direct bond is converted to the corresponding alkali metal salt of bisphenol in the same manner as described above. Next, this alkali metal salt of bisphenol is reacted with a halogen atom such as chlorine and a benzonitrile compound substituted by a nitrile group.

The benzonitrile compounds include, for example, 2,6-dichlorobenzonitrile, 2,6-difluorobenzonitrile, 2,5-dichlorobenzonitrile, 2,5-difluorobenzonitrile, 2,4-dichlorobenzbnitrile, 2,4-difluorobenzonitrile, 2,6-dinitrobenzonitrile, 2,5-dinitrobenzonitrile and 2,4-dinitrobenzonitrile. Among them, dichlorobenzonitrile compounds are preferred, and 2,6-dichlorobenzonitrile is more preferred.

The benzonitrile compound is used in an amount of 1.0001 to 3 times by mole, preferably 1.001 to 2 times by mole based on the amount of the bisphenol. A method may also be adopted in which, after the completion of the reaction, the reaction may be further carried out, for example, by adding an excessive amount of 2,6-dichlorobenzonitrile so that both ends are a chlorine atom. When a difluorobenzonitrile compound or a dinitrobenzonitrile compound is used, the reaction should be designed so that both ends are a chlorine atom, for example, by adding the dichlorobenzonitrile compound in the second half of the reaction.

Regarding reaction conditions, the reaction temperature is 60° C. to 300° C., preferably 80° C. to 250° C., and the reaction time is 15 min to 100 hr, preferably one hr to 24 hr.

The resulting oligomer or polymer may be purified by conventional polymer purification methods, for example, dissolution-precipitation. The molecular weight may be modified by varying the reaction molar ratio between the excessive aromatic dichloride and the bisphenol. Since the amount of the aromatic dichloride of which the nitrile group has been substituted is excessive, the molecular end of the resultant oligomer or polymer is an aromatic chloride of which the nitrile group has been substituted.

Monomers (3′) having on the molecular end thereof an aromatic chloride of which the nitrile group has been substituted include, for example, the following compounds.

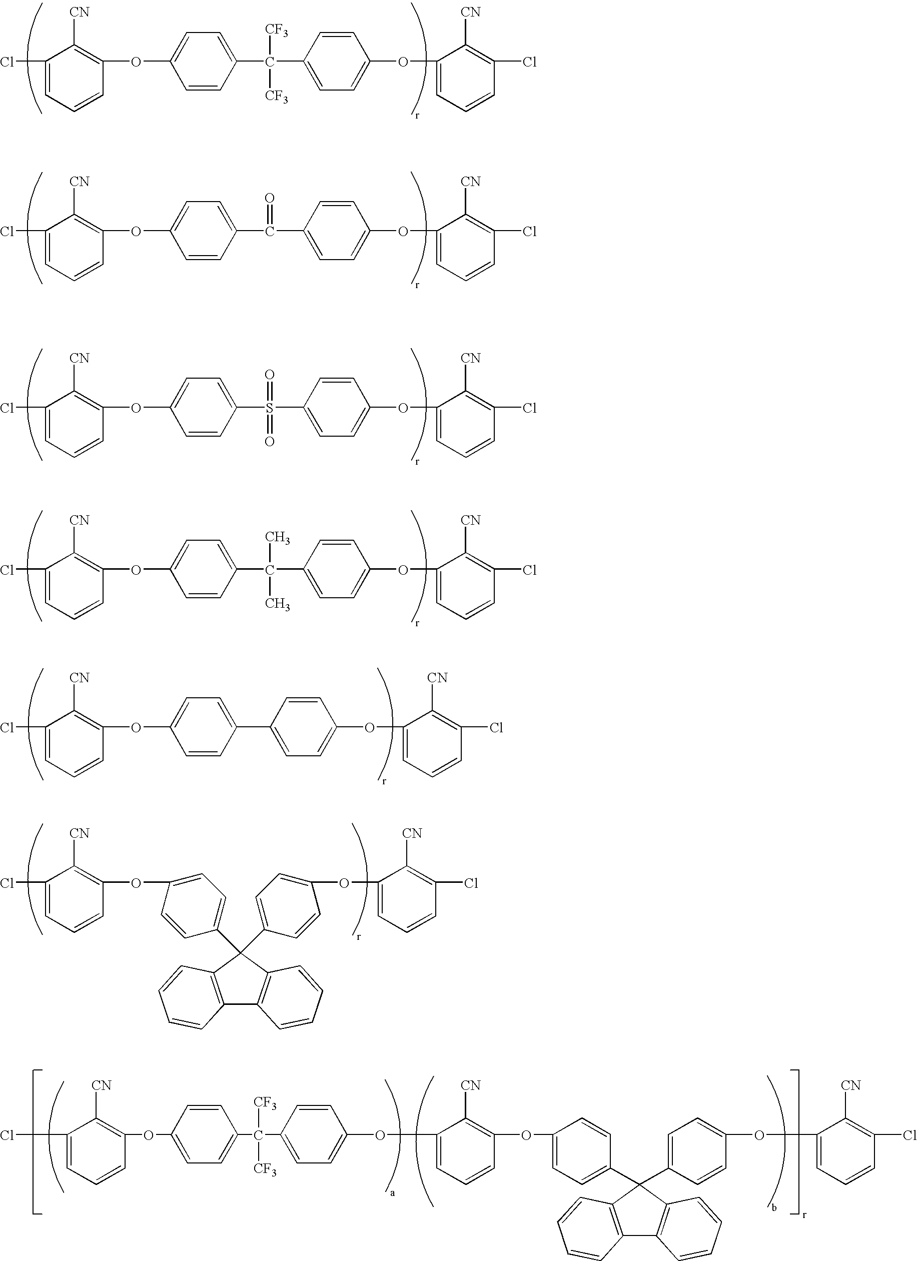

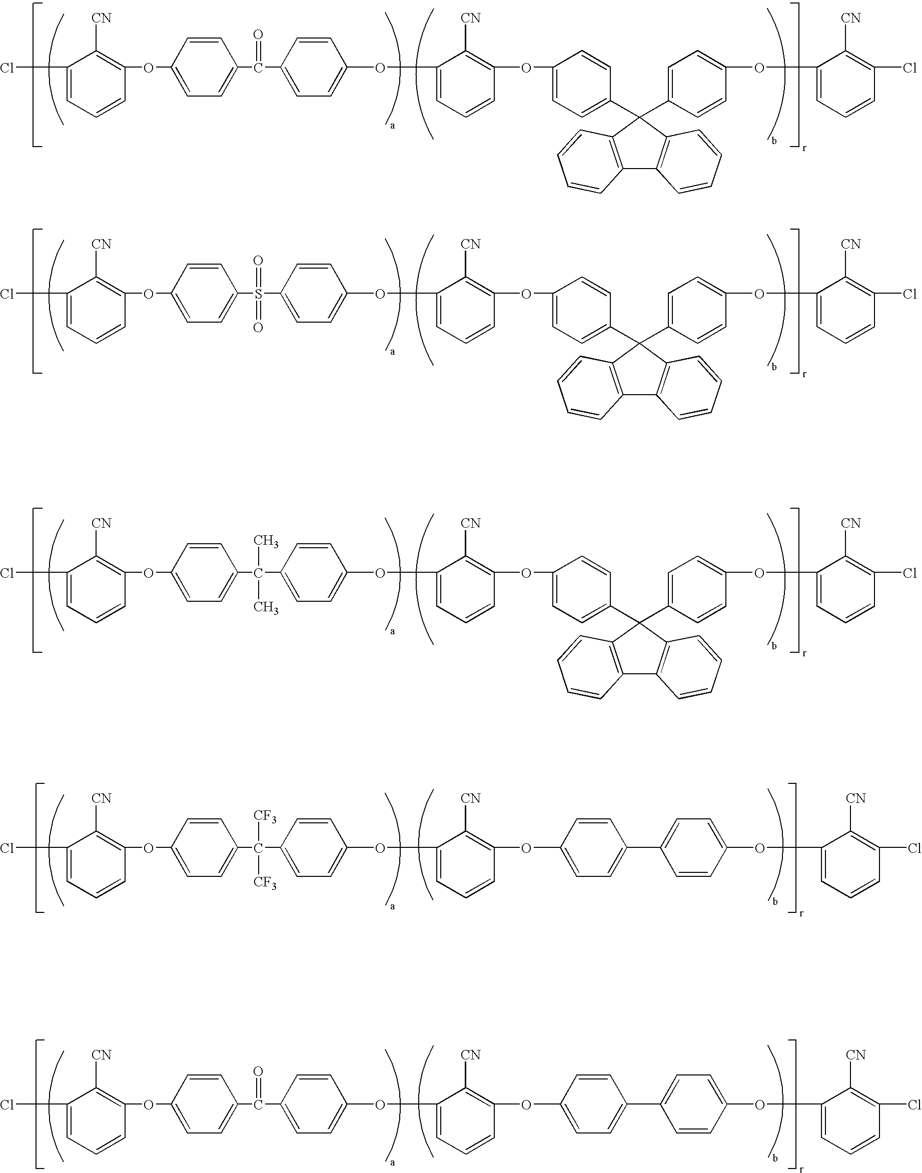

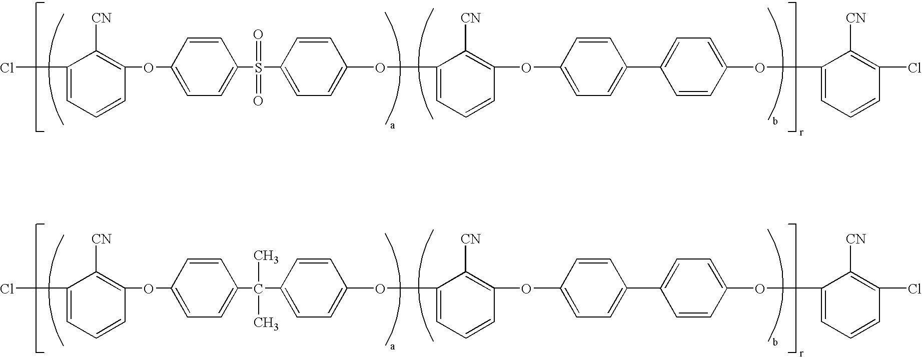

The sulfonic ester group-containing polyarylene is synthesized by reacting the monomer (1′) with the monomer (2′) or (3′) in the presence of a catalyst system containing a transition metal compound. This catalyst system may comprise, as indispensable components, (i) a transition metal salt and a compound as a ligand (hereinafter often referred to as “ligand component”), or a transition metal complex (including a copper salt) to which a ligand has been coordinated, and (ii) a reducing agent, optionally a “salt” for enhancing the rate of polymerization.

Transition metal salts include, for example, nickel compounds such as nickel chloride, nickel bromide, nickel iodide and nickel acetyl acetate; palladium compounds such as palladium chloride, palladium bromide and palladium iodide; iron compounds such as iron chloride, iron bromide and iron iodide; and cobalt compounds such as cobalt chloride, cobalt bromide and cobalt iodide. Among them, nickel chloride and nickel bromide are preferred.

The ligand components include, for example, triphenylphosphine, 2,2′-bipyridine, 1,5-cyclooctadiene and 1,3-bis(diphenylphosphino)propane. Among them, triphenylphosphine and 2,2′-bipyridine are preferred. The ligand components may be used either alone or as a mixture of two or more of them.

Transition metal complexes to which the above ligand has been coordinated include, for example, nickel chloride bis(triphenylphosphine), nickel bromide bis(triphenylphosphine), nickel iodide bis(triphenylphosphine), nickel nitrate bis(triphenylphosphine), nickel chloride(2,2′-bipyridine), nickel bromide(2,2′-bipyridine), nickel iodide(2,2′-bipyridine), nickel nitrate(2,2′-bipyridine), bis(1,5-cyclooctadiene)nickel, tetrakis(triphenylphosphine)nickel, tetrakis(triphenylphosphite)nickel and tetrakis(triphenylphosphine)palladium. Among them, nickel chloride bis(triphenylphosphine) and nickel chloride(2,2′-bipyridine are preferred.

The reducing agents usable herein include, for example, iron, zinc, manganese, aluminum, magnesium, sodium and calcium. Among them, zinc, magnesium and manganese are preferred. These reducing agents may be more activated by bringing them into contact with an acid such as an organic acid.

“Salts” which can be added to the catalyst system include, for example, sodium compounds such as sodium fluoride, sodium chloride, sodium bromide, sodium iodide and sodium sulfate; potassium compounds such as potassium fluoride, potassium chloride, potassium bromide, potassium iodide and potassium sulfate; and ammonium compounds such as tetraethyl ammonium fluoride, tetraethyl ammonium chloride, tetraethyl ammonium bromide, tetraethyl ammonium iodide and tetraethyl ammonium sulfate. Among them, sodium bromide, sodium iodide, potassium bromide, tetraethyl ammonium bromide and tetraethyl ammonium iodide are preferred.

The transition metal salt or the transition metal complex is generally used in an amount of 0.0001 to 10 moles, preferably 0.01 to 0.5 mole, based on one mole in total of the above monomers (monomer (1′)+(2′) or monomer (1′)+(3′) the same shall apply hereinafter). When the amount of the transition metal salt or the transition metal complex used is below the above-defined range, in some cases, the polymerization reaction does not satisfactorily proceed. On the other hand, when the amount of the transition metal salt or the transition metal complex used is above the above-defined range, in some cases, the molecular weight is lowered.

In the catalyst system, when the transition metal salt and the ligand component are used, this ligand component is generally used in an amount of 0.1 to 100 moles, preferably 1 to 10 moles, based on one mole of the transition metal salt. When the amount of the ligand component used is below the above-defined range, in some cases, the catalytic activity is unsatisfactory. On the other hand, when the amount of the ligand component used exceeds the upper limit of the above-defined range, in some cases, the molecular weight is lowered.

The reducing agent is generally used in an amount of 0.1 to 100 moles, preferably 1 to 10 moles, based on one mol in total of the above monomers. When the amount of the reducing agent used is below the lower limit of the above-defined range, in some cases, the polymerization does not satisfactorily proceed. On the other hand, when the amount of the reducing agent used is above the upper limit of the above-defined range, in some cases, the purification of the polymer is difficult.

When the “salt” is added to the catalyst system, the “salt” is generally used in an amount of 0.001 to 100 moles, preferably 0.01 to 1 mol, based on one mol in total of the monomers. When the amount of the “salt” used is below the lower limit of the above-defined range, in some cases, the effect of enhancing the polymerization rate is unsatisfactory. On the other hand, when the amount of the “salt” used is above the upper limit of the above-defined range, in some cases, the purification of the polymer is difficult.

Polymerization solvents used in reacting the monomer (1′) with the monomer (2′) or (3′) include, for example, tetrahydrofuran, cyclohexanone, dimethyl sulfoxide, N,N-dimethylformamide, N,N-dimethylacetamide, N-methyl-2-pyrrolidone, γ-butyrolactone and N—N′-dimethylimidazolidinone. Among them, tetrahydrofuran, N,N-dimethylformamide, N,N-dimethylacetamide, N-methyl-2-pyrrolidone and N—N′-dimethylimidazolidinone are preferred. Preferably, these polymerization solvents are satisfactorily dried before use.

The total concentration of the monomers in the polymerization solvents is generally 1 to 90% by weight, preferably 5 to 40% by weight. Regarding the reaction conditions, the polymerization temperature is generally 0 to 200° C., preferably 50 to 120° C., and the polymerization time is generally 0.5 to 100 hr, preferably 1 to 40 hr.

A sulfonic acid group-containing polyarylene is produced by hydrolyzing the sulfonic ester group in the sulfonic ester group-containing polyarylene produced using the monomer (1′) as described above to convert the sulfonic ester group to a sulfonic acid group.

Methods usable for hydrolysis include:

(1) a method in which the sulfonic ester group-containing polyarylene is introduced into an excessive amount of water or alcohol containing a minor amount of hydrochloric acid, and the mixture is stirred for 5 min or longer;

(2) a method in which the sulfonic ester group-containing polyarylene is reacted in trifluoroacetic acid at a temperature of about 80 to 120° C. for about 5 to 10 hr; and

(3) a method in which the polyarylene is reacted in a solution containing lithium bromide in an amount of 1 to 3 times by mole based on one mole of the sulfonic ester group (—SO₃R) in the sulfonic ester group-containing polyarylene, for example, a solution of N-methylpyrrolidone, at a temperature of about 80 to 150° C. for about 3 to 10 hr, and hydrochloric acid is then added thereto.

The sulfonic acid group-containing polyarylene may also be synthesized by copolymerizing the same monomer as the monomer (1′) except for the absence of the sulfonic ester group with the monomer (2′) or (3′) to previously synthesize a nonsulfonated polyarylene and then sulfonating the nonsulfonated polyarylene with a sulfonating agent.

The sulfonation may be carried out by sulfonating the nonsulfonated polyarylene with a conventional sulfonating agent such as anhydrous sulfuric acid, fuming sulfuric acid, chlorosulfonic acid, sulfuric acid or sodium hydrogensulfite in the absence or presence of a solvent under conventional conditions (see for example, Polymer Preprints, Japan, Vol. 42, No. 3, p. 730 (1993); Polymer Preprints, Japan, Vol. 43, No. 3, p. 736 (1994); and Polymer Preprints, Japan, Vol. 42, No. 7, p. 2490 to 2492 (1993)).

Solvents usable in the sulfonation include, for example, hydrocarbon solvents such as n-hexane; ether solvents such as tetrahydrofuran and dioxane; aprotic polar solvents such as dimethylacetamide, dimethylformamide and dimethylsulfoxide; and halogenated hydrocarbons such as tetrachloroethane, dichloroethane, chloroform and methylene chloride.

Regarding reaction conditions, the reaction temperature is generally −50 to 200° C., preferably −10 to 100° C., and the reaction time is generally 0.5 to 1000 hr, preferably 1 to 200 hr.

The amount of the sulfonic acid group in the sulfonic acid group-containing polyarylene (sulfonic acid equivalent) produced by the above method is generally 0.3 to 5 meq/g, preferably 0.5 to 3 meq/g, more preferably 0.8 to 2.8 meq/g. When the sulfonic acid equivalent is below the lower limit of the above-defined range, the proton conductivity is low and is not practical. On the other hand, when the sulfonic acid equivalent is above the upper limit of the above-defined range, in some cases, the water resistance is disadvantageously significantly lowered. This sulfonic acid equivalent can be regulated, for example, by varying the type, proportion used, combination and the like of the monomers (1′) to (3′).

The weight average molecular weight of the sulfonated polyarylene is 10,000 to 1,000,000, preferably 20,000 to 800,000, as determined by gel permeation chromatography (GPC) using polystyrene as a standard.

The structure of the sulfonated polyarylene can be confirmed by an infrared absorption spectrum, for example, by S═O absorption at 1030 to 1045 cm⁻¹ and 1160 to 1190 cm⁻¹, C—O—C absorption at 1130 to 1250 cm⁻¹, and C═O absorption at 1640 to 1660 cm⁻¹, and the composition ratio thereof can be learned by neutralization titration of sulfonic acid or elementary analysis. Further, the structure can be confirmed from aromatic proton peaks of 6.8 to 8.0 ppm by using a nuclear magnetic resonance spectrum (¹H-NMR).

The solid polymer electrolyte membrane (hereinafter often referred to as “proton conductive membrane”) constituting MEA according to the present invention comprises a composition containing the above sulfonated polyarylene (hereinafter often referred to as “proton conductor composition”), and this composition may contain, for example, antioxidants and anti-aging agents such as phenolic hydroxyl group-containing compounds, amine compounds, organic phosphorus compounds, and organic sulfur compounds, so far as the proton conductivity is not sacrificed.

The anti-aging agent is preferably a hindered phenol compound having a molecular weight of not less than 500, and the incorporation of this anti-aging agent can further improve the durability as the electrolyte.

The hindered phenol compounds usable as anti-aging agent include, for example, triethylene glycol-bis[3-(3-t-butyl-5-methyl-4-hydroxyphenyl)propionate] (tradename: IRGANOX 245), 1,6-hexanediol-bis[3-(3,5-di-t-butyl-4-hydroxyphenyl)propionate] (tradename: IRGANOX 259), 2,4-bis-(n-octylthio)-6-(4-hydroxy-3,5-di-t-butylanilino)-3,5-triazine (tradename: IRGANOX 565), pentaerythrityl-tetrakis[3-(3,5-di-t-butyl-4-hydroxyphenyl)propionate] (tradename: IRGANOX 1010), 2,2-thio-diethylenebis[3-(3,5-di-t-butyl-4-hydroxyphenyl)propionate] (tradename: IRGANOX 1035), octadecyl-3-(3,5-di-t-butyl-4-hydroxyphenyl)propionate (tradename: IRGANOX 1076), N,N-hexamethylene bis(3,5-di-t-butyl-4-hydroxy-hydrocinnamide) (tradename: IRGANOX 1098), 1,3,5-trimethyl-2,4,6-tris(3,5-di-t-butyl-4-hydroxybenzyl)benzene (tradename: IRGANOX 1330), tris-(3,5-di-t-butyl-4-hydroxybenzyl)-isocyanurate (tradename: IRGANOX 3114) and 3,9-bis[2-[3-(3-t-butyl-4-hydroxy-5-methylphenyl)propionyloxy]-1,1-dimethylethyl]-2,4,8,10-tetraoxaspiro[5.5]undecane (tradename: Sumilizer GA-80).

The hindered phenol compound is preferably used in an amount of 0.01 to 10 parts by weight based on 100 parts by weight of the sulfonated polyarylene.

The proton conductor composition may be produced, for example, by mixing the above components at a predetermined ratio and further mixing the mixture by a conventional method, specifically by a high-shear mixer such as a homogenizer, a disperser, a paint conditioner or ball mill. In this case, a solvent may be used.

The method for producing the proton conductive membrane using the proton conductor composition is not particularly limited, and examples thereof include a casting method which comprises dissolving a proton conductor composition containing the sulfonated polyarylene in a solvent to prepare a solution, and casting the solution onto a substrate to shape the solution into a film. In forming a proton conductive membrane, for example, an inorganic acid such as sulfuric acid or phosphoric acid, an organic acid including a carboxylic acid or a suitable amount of water may be used in combination with the proton conductor composition.

The substrate is not particularly limited so far as it is a substrate commonly used in conventional solution casting methods. For example, plastic or metallic substrates are used, and substrates formed of thermoplastic resins such as polyethylene terephthalate (PET) films are preferred.

Solvents usable for dissolving the proton conductor composition include aprotic polar solvents such as N-methyl-2-pyrrolidone, N,N-dimethylformamide, γ-butyrolactone, N,N-dimethylacetamide, dimethyl sulfoxide, dimethylurea and dimethylimidazolidinone. Among them, N-methyl-2-pyrrolidone (NMP) is preferred from the viewpoint of dissolvability and solution viscosity. The aprotic polar solvents may be used either singly or in combination of two or more kinds.

The solvent may also be a mixture composed of the aprotic polar solvent with an alcohol. Such alcohols include, for example, methanol, ethanol, propyl alcohol, iso-propyl alcohol, sec-butyl alcohol and tert-butyl alcohol. Among them, methanol is preferred because the effect of lowering the viscosity of the solution can attained in a wide composition range. The alcohols may be used either singly or in combination of two or more kinds.

When the mixture composed of the aprotic polar solvent and the alcohol is used as the solvent, the content of the aprotic polar solvent is 95 to 2.5% by weight, preferably 90 to 25% by weight, and the content of the alcohol is 5 to 75% by weight, preferably 10 to 75% by weight. In this case, the total of the aprotic polar solvent and the alcohol content is 100% by weight. When the alcohol content is in the above-defined range, the effect of lowering the viscosity of the solution is excellent.

In this case, the concentration of the polymer is generally 5 to 40% by weight, preferably 7 to 25% by weight, although the concentration may vary depending upon the molecular weight of the sulfonated polyarylene. When the polymer concentration is below the lower limit of the above-defined range, it is difficult to increase the thickness of the membrane, resulting in an increased tendency toward the formation of pinholes. On the other hand, when the polymer concentration is above the upper limit of the above-defined range, the solution viscosity is so high that, in some cases, film formation becomes difficult and the surface smoothness is insufficient.

The solution viscosity is generally 2,000 to 100,000 mPa·s, preferably 3,000 to 50,000 mPa·s, although it varies depending upon the molecular weight of the sulfonated polyarylene and the polymer concentration. When the solution viscosity is below the lower limit of the above-defined range, the retentivity of the solution during film formation is so low that the solution sometimes flows out of the substrate. On the other hand, when the solution viscosity is above the above-defined range, the viscosity of the solution is so high that the solution cannot be extruded through a die and, consequently, in some cases, the film formation by casting becomes difficult.

After the formation of the film by the above method, when the undried film is immersed in water, the organic solvent in the undried film can be replaced with water. As a result, the amount of the residual solvent in the proton conductive membrane can be reduced. After the film formation, before the undried film is immersed in water, the undried film may be predried. The predrying may generally be carried out by holding the undried film at a temperature of 50 to 150° C. for 0.1 to 10 hr.

The undried film may be immersed in water by a batch method in which the sheet is immersed in water, or a continuous method in which a laminate film formed on a base material film (for example, PET), which is an ordinary form, as such or a membrane (film) separated from the substrate is immersed in water and is taken up.

In the case of the batch method, in order to suppress wrinkle formation on the surface of the treated film, for example, a method is preferably adopted in which the treated film is fastened in a frame.

In immersing the undried film in water, the contact ratio is such that the amount of water is not less than 10 parts by weight, preferably not less than 30 parts by weight, based on one part by weight of the undried film. In order to minimize the amount of the residual solvent of the proton conductive membrane, the contact ratio is preferably at the largest possible value. Further, the replacement or overflow of water used in the immersion to always keep the concentration of the organic solvent in water at a given concentration or below is also effective in reducing the amount of the residual solvent in the proton conductive membrane. In order to suppress, to a low level, the in-plane distribution of the amount of the organic solvent which stays in the proton conductive membrane, the concentration of the organic solvent in water is effectively rendered uniform by stirring or the like.

In immersing the undried film in water, the temperature of water is generally 5 to 80° C., preferably 10 to 60° C. The higher the temperature, the higher the displacement rate between the organic solvent and water. In this case, however, the amount of water absorption of the film is larger. Therefore, there is a fear of causing roughening of the surface of the proton conductive membrane after drying. The immersion time is generally 10 min to 240 hr, preferably 30 min to 100 hr, although the immersion time varies depending upon the initial residual solvent content, contact ratio and treatment temperature.

As described above, when the undried film is immersed in water and then dried, a proton conductive membrane having a reduced residual solvent content is obtained. In the proton conductive membrane thus obtained, the residual solvent content is generally not more than 5% by weight.

Under some immersion conditions, the residual solvent content of the proton conductive membrane can be brought to not more than 1% by weight. For example, this residual solvent content can be realized by bringing the contact ratio between the undried film and water (water/undried film, weight ratio) to not less than 50, bringing the temperature of water at the time of immersion to 10 to 60° C., and bringing the immersion time to 10 min to 10 hr.

After immersion of the undried film in water in the above manner, the proton conductive membrane can be produced by drying the film at 30 to 100° C., preferably 50 to 80° C., for 10 to 180 min, preferably 15 to 60 min, and then vacuum drying the film at 50 to 150° C., preferably under a reduced pressure of 500 mmHg to 0.1 mmHg, for 0.5 to 24 hr.

The proton conductive membrane formed by the above method generally has a thickness of 10 to 100 μm, preferably 20 to 80 μm, on a dry basis.

Alternatively, the proton conductive membrane formed of a sulfonic acid group-containing polyarylene can be produced by forming the sulfonic ester group-containing polyarylene into a film in the same manner as described above without hydrolysis and then hydrolyzing the film by the same hydrolysis method as described above.

In the membrane-electrode assembly according to the present invention, the proton conductive membrane is held between the oxygen electrode and the fuel electrode. The oxygen electrode and the fuel electrode each comprise a diffusing layer and a catalyst layer provided on the diffusing layer, and they are brought into contact with the proton conductive membrane on the catalyst layer side.

The diffusing layer may be any layer so far as the layer is permeable to gas and has electron conductivity. The diffusing layer is generally formed of carbon paper and a substrate layer. The substrate layer may be formed, for example, by homogeneously dispersing a mixture composed of carbon black and polytetrafluoroethylene (PTFE) at a predetermined weight ratio in an organic solvent such as ethylene glycol to prepare a slurry, coating the slurry on one side of the carbon paper and drying the coating.

The catalyst layer is formed of an electrically conductive material, a binder, a catalyst metal and the like. Carbon materials and various metals may be used as the electrically conductive material, and examples thereof include carbon black and graphite. Examples of the binders include perfluorosulfonic acid resins and sulfonated aromatic polymer resins. Catalyst metals include platinum, ruthenium, rhodium and alloys thereof.

The catalyst layer may be formed, for example, by homogeneously mixing catalyst particles comprising platinum supported on carbon black at a predetermined weight ratio and an ion conductive binder together to prepare a catalyst paste, coating the catalyst paste onto the diffusing layer, and drying the coating.

The membrane-electrode assembly may be formed by holding the proton conductive membrane between the catalyst layer in the oxygen electrode and the catalyst layer in the fuel electrode and hot pressing the assembly in this state.

The solid polymer fuel cell according to the present invention comprising the membrane-electrode assembly according to the present invention is excellent in power generation performance and durability even under a severe environment, such as under high-temperature conditions.

### EXAMPLES

The present invention will be hereinafter described in greater detail by Examples presented below, but it should be construed that the invention is in no way limited to those Examples. Measurements for various items in the Examples were carried out as follows.

(Molecular Weight)

The polyarylene having no sulfonic group was analyzed by GPC using a tetrahydrofuran (THF) solvent to measure the molecular weight in terms of polystyrene. The polyarylene having a sulfonic group was analyzed by GPC using a solvent (eluting solution) consisted of N-methyl-2-pyrrolidone (NMP) mixed with lithium bromide and phosphoric acid, to measure the molecular weight in terms of polystyrene. In the following description, “Mn” represents a number average molecular weight, and “Mw” represents a weight average molecular weight.

(Creep Resistance)

The creep resistance was measured as a thickness reduction (%) of a membrane-electrode assembly after applying a load of a contact pressure of 5 kg/cm² to the assembly under an environment of temperature 90° C. and relative humidity 90% for 1000 hr. For the thickness reduction, the smaller the numerical value, the higher the creep resistance.

(Power Generation Performance)

The membrane-electrode assembly was used as a single cell, and power generation was carried out by supplying oxygen to an oxygen electrode while supplying pure hydrogen to a fuel electrode. Conditions for power generation were temperature 90° C., relative humidity on the fuel electrode side 50%, and relative humidity on the oxygen electrode side 80%. The cell voltage at a current density of 0.5 A/cm² was measured, and a cell voltage of not less than 0.4 V was evaluated as providing good power generation performance.

(Durability Against Power Generation)

When any cross leakage on the fuel electrode side or oxygen electrode side was not observed during continuous power generation for 1000 hr under the above conditions, the durability against power generation was evaluated as good.

### Synthesis Example 1

A 1-L three-necked flask provided with a stirrer, a thermometer, a cooling pipe, a Dean-Stark pipe and a three-way cock for nitrogen introduction was charged with 67.3 g (0.20 mol) of 2,2-bis(4-hydroxyphenyl)-1,1,1,3,3,3-hexafluoropropane (bisphenol AF), 60.3 g (0.24 mol) of 4,4′-dichlorobenzophenone(4,4′-DCBP), 71.9 g (0.52 mol) of potassium carbonate, 300 mL of N,N-dimethylacetamide (DMAc) and 150 mL of toluene. The flask was heated in an oil bath in a nitrogen atmosphere, and a reaction was allowed to proceed at 130° C. with stirring. When the reaction was allowed to proceed while azeotroping water being produced by the reaction with toluene and removing the water through the Dean-Stark pipe to the outside of the reaction system, about 3 hr after the start of the reaction, the production of water became substantially no longer observed. Thereafter, the reaction temperature was gradually raised from 130° C. to 150° C. to remove a major part of toluene, and a reaction was continued at 150° C. for 10 hr. 4,4′-DCBP (10.0 g, 0.040 mol) was then added to the residue, and a reaction was allowed to proceed for additional 5 hr. The reaction solution was then allowed to cool, and the precipitate of the by-produced inorganic compound was removed by filtration. The filtrate was introduced into 4 L of methanol. The precipitated product was filtered, dried, and was then dissolved in 300 mL of tetrahydrofuran. The solution was introduced into 4 L of methanol for reprecipitation to give 95 g (yield 85%) of a contemplated compound.

Mn of the resultant compound determined by GPC (THF solvent) in terms of polystyrene was 11,200. Further, it was confirmed that the resultant compound was an oligomer (hereinafter often referred to as “oligomer (I)”) which was soluble in THF, NMP, DMAc, sulfolane and the like, had a Tg (glass transition temperature) of 110° C. and a heat decomposition temperature of 498° C., and is represented by the following formula (I).

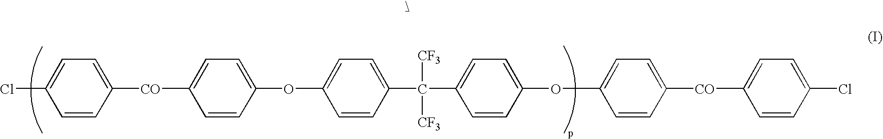

### Synthesis Example 2

A 1-L three-necked flask provided with a stirrer, a thermometer, a Dean-Stark pipe, a nitrogen introduction pipe and a cooling pipe was charged with 48.2 g (0.28 mol) of 2,6-Dichlorobenzonitrile, 89.5 g (0.27 mol) of 2,2-bis(4-hydroxyphenyl)-1,1,1,3,3,3-hexafluoropropane and 47.8 g (0.35 mol) of potassium carbonate. The air in the flask was replaced by nitrogen, 346 mL of sulfolane and 173 mL of toluene were then added thereto. The mixture was stirred, and the reaction solution was heated under reflux in an oil bath at 150° C. Water produced by the reaction was trapped in the Dean-stark pipe. Three hr after the initiation of the reaction, the production of water became substantially no longer observed, and toluene was removed through the Dean-stark pipe to the outside of the system. The reaction temperature was gradually raised to 200° C., and stirring was continued for 3 hr, 9.2 g (0.053 mol) of 2,6-dichlorobenzonitrile was then added, and a reaction was allowed to proceed for additional 5 hr.

The reaction solution was allowed to cool, and was then diluted by the addition of 100 mL of toluene. The inorganic salt insoluble in the reaction solution was filtered, and the filtrate was poured into 2 L of methanol to precipitate the product. The precipitated product was collected by filtration, was dried, and was then dissolved in 250 mL of tetrahydrofuran. The solution was poured into 2 L of methanol for reprecipitation. The precipitated white powder was filtered and was dried to give 109 g of the contemplated compound. Mn of the compound thus obtained was measured by GPC and was found to be 9,500. It was confirmed that the compound thus obtained was an oligomer represented by the following formula (II) (hereinafter often referred to as “oligomer (II)”).

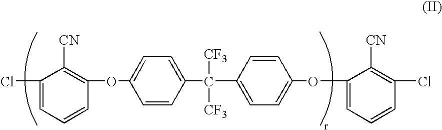

### Synthesis Example 3

A 1-L three-necked flask provided with a stirrer, a thermometer, a Dean-Stark pipe, a nitrogen introduction pipe and a cooling pipe was charged with 24.1 g (0.072 mol) of 2,2-Bis(4-hydroxyphenyl)-1,1,1,3,3,3-hexafluoro-propane, 10.1 g (0.029 mol) of 9,9-bis(4-hydroxyphenyl)fluorene, 19.7 g (0.115 mol) of 2,6-dichlorobenzonitrile and 18.0 g (0.130 mol) of potassium carbonate. The air in the flask was replaced by nitrogen, 135 mL of sulfolane and 67 mL of toluene were then added thereto. The mixture was stirred, and the reaction solution was heated under reflux in an oil bath at 150° C. Water produced by the reaction was trapped in the Dean-stark pipe. Three hr after the initiation of the reaction, the production of water became substantially no longer observed, and toluene was removed through the Dean-stark pipe to the outside of the reaction system. The reaction temperature was gradually raised to 200° C., and stirring was continued for 5 hr, 9.80 g (0.057 mmol) of 2,6-dichlorobenzonitrile was then added, and the reaction was allowed to proceed for additional 3 hr.

The reaction solution was allowed to cool, and was then diluted by the addition of 100 mL of toluene. The inorganic salt insoluble in the reaction solution was filtered, and the filtrate was poured into 2 L of methanol to precipitate the product. The precipitated product was collected by filtration, was dried, and was dissolved in 250 mL of tetrahydrofuran. The solution was poured into 2 L of methanol for reprecipitation. The precipitated white powder was filtered and was dried to give 40.1 g of the contemplated compound. Mn of the compound thus obtained was measured by GPC and was found to be 7,400. It was confirmed that the compound thus obtained was an oligomer represented by the following formula (III) (hereinafter often referred to as “oligomer (III)”).

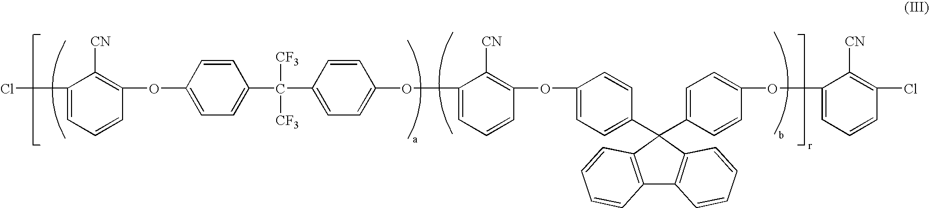

In the formula (III), the ratio between a and b (a:b) was 71:29. The constituents represented by the number of repetitions a and b are referred to also as “component a” and “component b”, respectively.

### Example 1

(1) Synthesis of Sulfonated Polyarylene

A 1-L three-necked flask equipped with a stirrer, a thermometer, a cooling pipe, a Dean-stark pipe and a three-way cock for nitrogen introduction was charged with 51.81 g (99.0 mmol) of a compound containing a sulfonic ester group (—SO₃neoPe) represented by formula (IV), 11.20 g (1.0 mmol) of the oligomer (I) produced by Synthesis Example 1, 1.67 g (2.55 mmol) of Ni(PPh₃)₂Cl₂, 10.49 g (40.0 mmol) of PPh₃, 0.45 g (3.0 mmol) of NaI, 15.69 g (240 mmol) of zinc powder and 390 mL of dry NMP, under nitrogen.

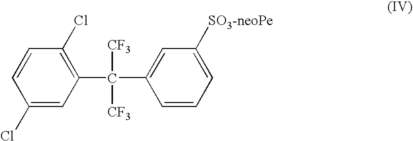

Next, the reaction system was heated with stirring (heated finally to 75° C.), and a reaction was allowed to proceed for 3 hr. The polymerization reaction solution was diluted with 250 mL of THF, and the diluted solution was stirred for 30 min and was filtered using Celite as a filter aid. The filtrate was poured into a large excess of methanol (1500 mL) for coagulation. The coagulate was collected by filtration, was air dried, and was further redissolved in THF (200 ml)/NMP (300 mL). This solution was poured into large excess of methanol (1500 mL) for coagulation and precipitation. After air drying, the precipitate was heat dried to give 52.3 g (yield 94%) of a contemplated yellow fibrous sulfonic ester group-containing copolymer. The molecular weight of the copolymer was measured by GPC and was found to be Mn=43,100 and Mw=143,000.

The sulfonic ester group-containing copolymer (5.1 g) was dissolved in 60 mL of NMP, and the solution was heated to 90° C. A mixture of 50 mL of methanol with 8 mL of concentrated hydrochloric acid was added at a time to the reaction system to prepare a suspension, and a reaction was allowed to proceed under mild reflux conditions for 10 hr. A distillation apparatus was installed, and the excess methanol was removed by evaporation to give a light green transparent solution. This solution was poured into a large amount of water/methanol (weight ratio=1:1) to coagulate the polymer, and the polymer was then washed with ion exchanged water until pH of the washed water reached 6 or higher.

The polymer thus obtained was subjected to IR spectrum measurement and quantitative analysis of the ion exchange capacity. As a result, it was confirmed that the sulfonic ester group (—SO₃R) was quantitatively converted to a sulfonic acid group (—SO₃H). The molecular weight of the sulfonic acid group-containing polyarylene (hereinafter often referred to as “sulfonated polyarylene (V)”) was measured by GPC and was found to be Mn=55,400 and Mw=162,000, and the sulfonic acid equivalent was 1.9 meq/g. The polymer thus obtained was estimated to be a sulfonated polymer represented by the following formula (V). 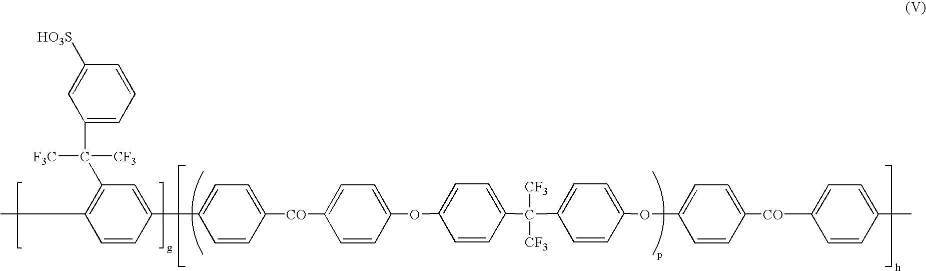
(2) Preparation of Proton Conducting Membrane

A 10 wt % N-methylpyrrolidone (NMP) solution of the sulfonated polyarylene (V) thus obtained was cast on a glass plate for film formation to form a 40 μm-thick film (a proton conducting membrane).

(3) Preparation of Membrane-Electrode Assembly

The proton conducting membrane thus obtained was held between an oxygen electrode and a fuel electrode, and the assembly was hot pressed several times under conditions of 160° C., 5 MPa and 2 min per time to prepare a membrane-electrode assembly (MEA). The oxygen electrode and the fuel electrode were formed as follows.

Carbon black and polytetrafluoroethylene (PTFE) particles were first mixed together at a weight ratio of carbon black:PTFE=4:6, and the mixture was homogeneously dispersed in ethylene glycol to prepare slurry. This slurry was coated onto one side of carbon paper, and the coating was dried to form a substrate layer and thus to form a diffusing layer comprising carbon paper and the substrate layer.

Next, catalyst particles comprising platinum particles supported on carbon black (furnace black) at a platinum particles:carbon black weight ratio of 1:1 were mixed with an ion conducting binder at a catalyst particles:ion conducting binder weight ratio of 8:5 followed by homogeneous dispersion to prepare catalyst paste. The above sulfonated polyarylene (V) was used as the ion conducting binder.

Next, the catalyst paste was screen printed on the diffusing layer so that the amount of platinum was 0.5 mg/cm². The coating was dried at 60° C. for 10 min and was vacuum dried at 120° C. Thus, a cathode and an anode were prepared.

### Example 2

(1) Synthesis of Sulfonated Polyarylene

A 1-L three-necked flask equipped with a stirrer, a thermometer, a cooling pipe, a Dean-stark pipe and a three-way cock for nitrogen introduction was charged with 51.81 g (99.0 mmol) of a compound containing a sulfonic ester group (—SO₃neoPe) represented by the formula (IV), 9.50 g (1.0 mmol) of the oligomer (II) produced by Synthesis Example 2, 1.67 g (2.55 mmol) of Ni(PPh₃)₂Cl₂, 10.49 g (40.0 mmol) of PPh₃, 0.45 g (3.0 mmol) of NaI and 15.69 g (240 mmol) of zinc powder. The air in the flask was replaced by nitrogen, 400 mL of N,N-Dimethylacetamide (DMAc) was added thereto under nitrogen, and stirring was continued for 3 hr while maintaining the reaction temperature at 80° C. Thereafter, 250 mL of DMAc was added for dilution, and insolubles were removed by filtration.

The solution thus obtained was charged into a 2-L flask equipped with a stirrer, a thermometer and a nitrogen introduction pipe, and the solution was heated at 115° C. with stirring, and 18.9 g (218 mmol) of lithium bromide was added thereto. The mixture was stirred for 7 hr and was then poured into 5 L of acetone to precipitate the product, and the precipitate was collected by filtration, was washed with 1 N hydrochloric acid and pure water in that order, and was then dried to give 32.4 g of the contemplated polymer. The polymer thus obtained was subjected to IR spectrum measurement and quantitative analysis of the ion exchange capacity. As a result, it was confirmed that the sulfonic ester group (—SO₃R) was quantitatively converted to a sulfonic acid group (—SO₃H). The molecular weight of the sulfonic acid group-containing polyarylene (hereinafter often referred to as “sulfonated polyarylene (VI)”) was measured by GPC and was found to be Mn=42,700 and Mw=137,000, and the sulfonic acid equivalent was 2.0 meq/g. The polymer thus obtained was estimated to be a sulfonated polymer represented by the following formula (VI). 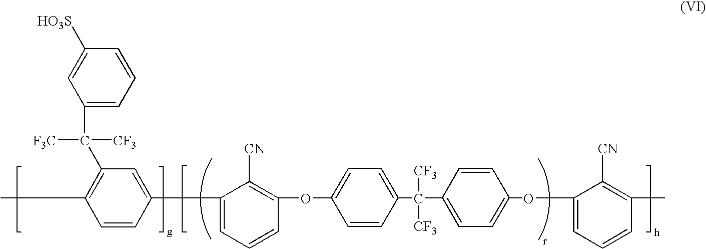
(2) Preparation of Proton Conducting Membrane

A proton conducting membrane was prepared in the same manner as in Example 1, except that the sulfonated polyarylene (VI) thus obtained was used.

(3) Preparation of Membrane-Electrode Assembly

MEA was prepared in the same manner as in Example 1, except that the proton conducting membrane was used and the sulfonated polyarylene (VI) was used as the ion conducting binder for the electrode.

### Example 3

(1) Synthesis of Sulfonated Polyarylene

A 1-L three-necked flask equipped with a stirrer, a thermometer, a cooling pipe, a Dean-stark pipe and a three-way cock for nitrogen introduction was charged with 51.65 g (98.7 mmol) of a compound containing a sulfonic ester group (—SO₃neoPe) represented by the formula (IV), 9.62 g (1.3 mmol) of the oligomer (III) produced by Synthesis Example 3, 1.67 g (2.55 mmol) of Ni(PPh₃)₂Cl₂, 10.49 g (40.0 mmol) of PPh₃, 0.45 g (3.0 mmol) of NaI and 15.69 g (240 mmol) of zinc powder. The air in the flask was replaced by nitrogen, 400 mL of N,N-Dimethylacetamide (DMAc) was added thereto under nitrogen, and stirring was continued for 3 hr while maintaining the reaction temperature at 80° C. Thereafter, 250 mL of DMAc was added for dilution, and insolubles were removed by filtration.

The solution thus obtained was charged into a 2-L flask equipped with a stirrer, a thermometer and a nitrogen introduction pipe, and the solution was heated at 115° C. with stirring, and 18.9 g (218 mmol) of lithium bromide was added thereto. The mixture was stirred for 7 hr and was then poured into 5 L of acetone to precipitate the product, and the precipitate was collected by filtration, was washed with 1 N hydrochloric acid and pure water in that order, and was then dried to give 32.4 g of the contemplated polymer. The polymer thus obtained was subjected to IR spectrum measurement and quantitative analysis of the ion exchange capacity. As a result, it was confirmed that the sulfonic ester group (—SO₃R) was quantitatively converted to a sulfonic acid group (—SO₃H). The molecular weight of the sulfonic acid group-containing polyarylene (hereinafter often referred to as “sulfonated polyarylene (VII)”) was measured by GPC and was found to be Mn=43,400 and Mw=141,000, and the sulfonic acid equivalent was 1.9 meq/g. The polymer thus obtained was estimated to be a sulfonated polymer represented by the following formula (VII). 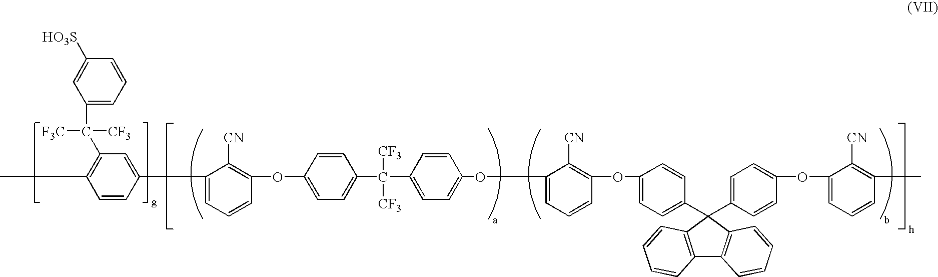
(2) Preparation of Proton Conducting Membrane

A proton conducting membrane was prepared in the same manner as in Example 1, except that the sulfonated polyarylene (VII) thus obtained was used.

(3) Preparation of Membrane-Electrode Assembly

MEA was prepared in the same manner as in Example 1, except that the proton conducting membrane was used and the sulfonated polyarylene (VII) was used as the ion conducting binder for the electrode.

### Example 4

(1) Synthesis of Sulfonated Polyarylene

A 1-L three-necked flask equipped with a stirrer, a thermometer, a cooling pipe, a Dean-stark pipe, and a three-way cock for nitrogen introduction was charged with 43.08 g (98.5 mmol) of a compound containing a sulfonic ester group (—SO₃neoPe) represented by formula (VIII), 16.80 g (1.50 mmol) of the oligomer (I) produced by Synthesis Example 1, 1.67 g (2.55 mmol) of Ni(PPh₃)₂Cl₂, 10.49 g (40.0 mmol) of PPh₃, 0.45 g (3.0 mmol) of NaI, 15.69 g (240 mmol) of zinc powder and 390 mL of dry NMP, under nitrogen.

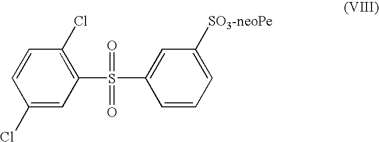

Next, the reaction system was heated with stirring (heated finally to 75° C.), and a reaction was allowed to proceed for 3 hr. The polymerization reaction solution was diluted with 250 mL of THF, and the diluted solution was stirred for 30 min and was filtered using Celite as a filter aid. The filtrate was poured into a large excess of methanol (1500 mL) for coagulation. The coagulate was collected by filtration, was air dried, and was further redissolved in THF (200 ml)/NMP (300 mL). A large excess of methanol (1500 mL) was added thereto for coagulation and precipitation. After air drying, the precipitate was heat dried to give 49.1 g (yield 93%) of a contemplated yellow fibrous sulfonic ester group-containing copolymer. The molecular weight of the copolymer was measured by GPC and was found to be Mn=44,900 and Mw=151,000.

The sulfonic ester group-containing copolymer (5.1 g) was dissolved in 60 mL of NMP, and the solution was heated to 90° C. A mixture of 50 mL of methanol with 8 mL of concentrated hydrochloric acid was added at a time to the reaction system to prepare a suspension, and a reaction was allowed to proceed under mild reflux conditions for 10 hr. A distillation apparatus was installed, and the excess methanol was removed by evaporation to give a light green transparent solution. This solution was poured into a large amount of water/methanol (weight ratio=1:1) to coagulate the polymer, and the polymer was then washed with ion exchanged water until pH of the washed water reached 6 or higher.

The polymer thus obtained was subjected to IR spectrum measurement and quantitative analysis of the ion exchange capacity. As a result, it was confirmed that the sulfonic ester group (—SO₃R) was quantitatively converted to a sulfonic acid group (—SO₃H). The molecular weight of the sulfonic acid group-containing polyarylene (hereinafter often referred to as “sulfonated polyarylene (IV)”) was measured by GPC and was found to be Mn=56,400 and Mw=171,000, and the sulfonic acid equivalent was 2.0 meq/g. The polymer thus obtained was estimated to be a sulfonated polymer represented by the following formula (IX). 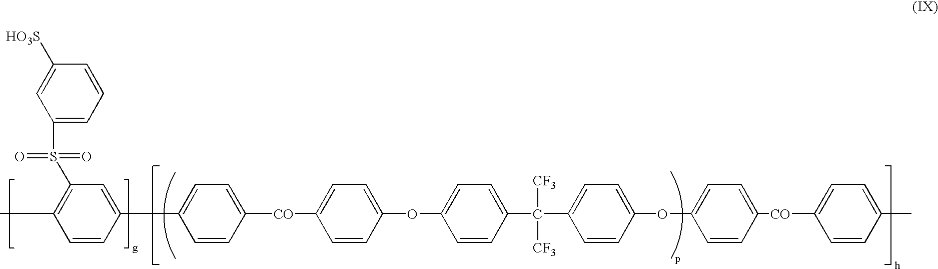
(2) Preparation of Proton Conducting Membrane

A proton conducting membrane was prepared in the same manner as in Example 1, except that the sulfonated polyarylene (IX) thus obtained was used.

(3) Preparation of Membrane-Electrode Assembly

MEA was prepared in the same manner as in Example 1, except that the proton conducting membrane was used and the sulfonated polyarylene (IX) was used as the ion conducting binder for the electrode.

### Example 5

(1) Synthesis of Sulfonated Polyarylene

A 1-L three-necked flask equipped with a stirrer, a thermometer, a cooling pipe, a Dean-stark pipe and a three-way cock for nitrogen introduction was charged with 42.87 g (98.0 mmol) of a compound containing a sulfonic ester group (—SO₃neoPe) represented by the formula (VIII), 19.00 g (2.0 mmol) of the oligomer (II) produced by Synthesis Example 2, 1.67 g (2.55 mmol) of Ni(PPh₃)₂Cl₂, 10.49 g (40.0 mmol) of PPh₃, 0.45 g (3.0 mmol) of NaI and 15.69 g (240 mmol) of zinc powder. The air in the flask was replaced by nitrogen, 400 mL of N,N-Dimethylacetamide (DMAc) was added thereto under nitrogen, and stirring was continued for 3 hr while maintaining the reaction temperature at 80° C. Thereafter, 250 mL of DMAc was added for dilution, and insolubles were removed by filtration.

The solution thus obtained was charged into a 2-L flask equipped with a stirrer, a thermometer and a nitrogen introduction pipe, and the solution was heated at 115° C. with stirring, and 18.7 g (216 mmol) of lithium bromide was added thereto. The mixture was stirred for 7 hr and was then poured into 5 L of acetone to precipitate the product, and the precipitate was collected by filtration, was washed with 1 N hydrochloric acid and pure water in that order, and was then dried to give 40.0 g of the contemplated polymer. The polymer thus obtained was subjected to IR spectrum measurement and quantitative analysis of the ion exchange capacity. As a result, it was confirmed that the sulfonic ester group (—SO₃R) was quantitatively converted to a sulfonic acid group (—SO₃H). The molecular weight of the sulfonic acid group-containing polyarylene (hereinafter often referred to as “sulfonated polyarylene (X)”) was measured by GPC and was found to be Mn=41,500 and Mw=131,000, and the sulfonic acid equivalent was 1.9 meq/g. The polymer thus obtained was estimated to be a sulfonated polymer represented by the following formula (X). 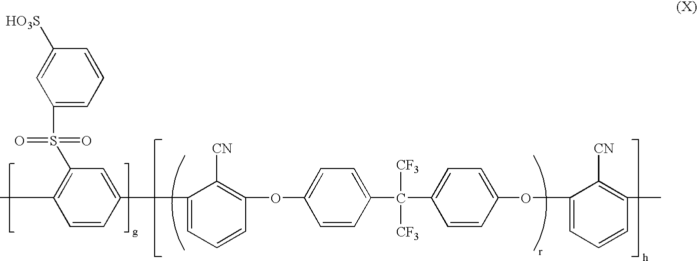
(2) Preparation of Proton Conducting Membrane

A proton conducting membrane was prepared in the same manner as in Example 1, except that the sulfonated polyarylene (X) thus obtained was used.

(3) Preparation of Membrane-Electrode Assembly

MEA was prepared in the same manner as in Example 1, except that the proton conducting membrane was used and the sulfonated polyarylene (X) was used as the ion conducting binder for the electrode.

### Example 6

(1) Synthesis of Sulfonated Polyarylene

A 1-L three-necked flask equipped with a stirrer, a thermometer, a cooling pipe, a Dean-stark pipe and a three-way cock for nitrogen introduction was charged with 42.65 g (97.5 mmol) of a compound containing a sulfonic ester group (—SO₃neoPe) represented by the formula (VIII), 18.50 g (2.5 mmol) of the oligomer (III) produced by Synthesis Example 3, 1.67 g (2.55 mmol) of Ni(PPh₃)₂Cl₂, 10.49 g (40.0 mmol) of PPh₃, 0.45 g (3.0 mmol) of NaI and 15.69 g (240 mmol) of zinc powder. The air in the flask was replaced by nitrogen, 400 mL of N,N-Dimethylacetamide (DMAc) was added thereto under nitrogen, and stirring was continued for 3 hr while maintaining the reaction temperature at 80° C. Thereafter, 250 mL of DMAc was added for dilution, and insolubles were removed by filtration.

The solution thus obtained was charged into a 2-L flask equipped with a stirrer, a thermometer and a nitrogen introduction pipe, and the solution was heated at 115° C. with stirring, and 18.6 g (215 mmol) of lithium bromide was added thereto. The mixture was stirred for 7 hr and was then poured into 5 L of acetone to precipitate the product, and the precipitate was collected by filtration, was washed with 1 N hydrochloric acid and pure water in that order, and was then dried to give 38.9 g of the contemplated polymer. The polymer thus obtained was subjected to IR spectrum measurement and quantitative analysis of the ion exchange capacity. As a result, it was confirmed that the sulfonic ester group (—SO₃R) was quantitatively converted to a sulfonic acid group (—SO₃H). The molecular weight of the sulfonic acid group-containing polyarylene (hereinafter often referred to as “sulfonated polyarylene (XI)”) was measured by GPC and was found to be Mn=45,800 and Mw=157,000, and the sulfonic acid equivalent was 1.9 meq/g. The polymer thus obtained was estimated to be a sulfonated polymer represented by the following formula (XI). 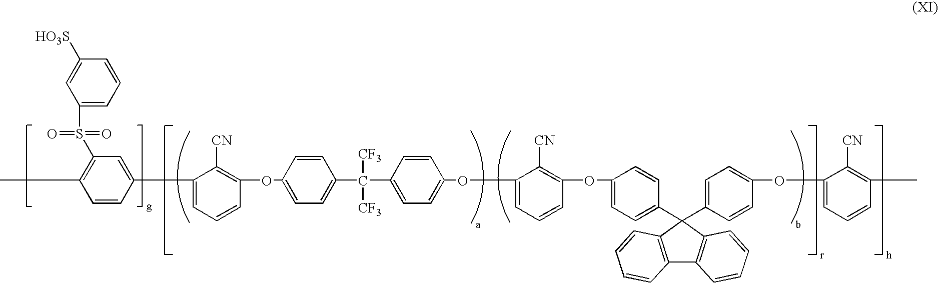
(2) Preparation of Proton Conducting Membrane

A proton conducting membrane was prepared in the same manner as in Example 1, except that the sulfonated polyarylene (XI) thus obtained was used.

(3) Preparation of Membrane-Electrode Assembly

MEA was prepared in the same manner as in Example 1, except that the proton conducting membrane was used and the sulfonated polyarylene (XI) was used as the ion conducting binder for the electrode.

### Comparative Example 1

A membrane-electrode assembly was prepared in the same manner as in Example 1, except that a membrane formed of a perfluoroalkylenesulfonic acid polymer compound (“Nafion 112” manufactured by Du Pont Ltd.) was used as the proton conducting membrane and Nafion was used as the ion conducting binder for the electrode.

### Comparative Example 2

(1) Preparation of Sulfonated Polyether Ether Ketone

Polyetherether ketone (PEEK) manufactured by Victrex, Inc. (3.0 g) was dissolved in concentrated sulfuric acid (150 mL), and a reaction was allowed to proceed at room temperature with stirring for 14 days. The mixture was introduced into a large amount of ether, and the resultant white precipitate was collected by filtration, was washed, and was then dried to give sulfonated polyether ether ketone. The sulfonated polyether ether ketone was dissolved in N,N-dimethylacetamide to give a 20 wt % solution.

(2) Preparation of Proton Conducting Membrane

The polymer solution was cast on a glass plate surrounded by silicone rubber (solution thickness 500 μm), and the coating was heated at 100° C. for 3 hr. Thereafter, the film thus obtained was separated from the glass plate to give a proton conducting membrane.

(3) Preparation of Membrane-Electrode Assembly

A membrane-electrode assembly was prepared in the same manner as in Example 1, except that the membrane prepared in the above item (2) was used as the proton conducting membrane and Nafion was used as the ion conducting binder for the electrode.

[Results of Evaluation]

The membrane-electrode assemblies prepared in the above Examples and Comparative Examples were evaluated as described above. The results of evaluation are shown in Table 1.

TABLE 1

| | | Power | Durability |
|---|---|---|---|
| | Creep | generation | against power |
| | resistance | performance | generation |
| Ex. 1 | −3 | good | good |
| Ex. 2 | −3 | good | good |
| Ex. 3 | −2 | good | good |
| Ex. 4 | −2 | good | good |
| Ex. 5 | −3 | good | good |
| Ex. 6 | −4 | good | good |
| Comp. Ex. 1 | −41 | good | non good |
| Comp. Ex. 2 | −7 | non good | non good |

1. A membrane-electrode assembly for fuel cell, in which a pair of electrodes each comprising a gas diffusing layer and a catalyst layer are joined respectively to both sides of a solid polymer electrolyte membrane so that said catalyst layer side comes into contact with the solid polymer electrolyte membrane,
said solid polymer electrolyte membrane comprises a sulfonated polyarylene comprising constituent unit represented by the following formula (1): 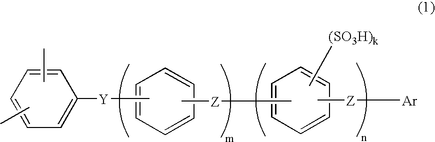
wherein Y is a group represented by —C(CF₃)₂—, —(CF₂)ᵢ—, wherein i is an integer of 1 to 10, —SO— or —SO₂—; Z is a divalent electron-donating group or a direct bond; Ar is an aromatic group having a substituent represented by —SO₃H; m is an integer of 0 to 10; n is an integer of 0 to 10; and k is an integer of 1 to 4.

2. The membrane-electrode assembly for fuel cell according to claim 1, wherein Y in the formula (1) is a group represented by —C(CF₃)₂— or —(CF₂)ᵢ— wherein i is an integer of 1 to 10.

3. The membrane-electrode assembly for fuel cell according to claim 1, wherein Y in the formula (1) is a group represented by —SO— or —SO₂—.

4. The membrane-electrode assembly for fuel cell according to claim 1, wherein the sulfonated polyarylene comprises constituent unit represented by the formula (1) and constituent unit represented by the following formula (2): 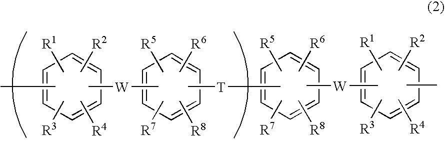
wherein R¹ to R⁸, which may be the same or different, are at least one atom or group selected from the group consisting of a hydrogen atom, a fluorine atom, an alkyl group, a fluorine-substituted alkyl group, an allyl group, an aryl group and a cyano group; W is a divalent electron withdrawing group or a direct bond; T is a divalent organic group or a direct bond; and p is 0 or a positive integer.

5. The membrane-electrode assembly for fuel cell according to claim 1, wherein the sulfonated polyarylene comprises constituent unit represented by the formula (1) and constituent unit represented by the following formula (3): 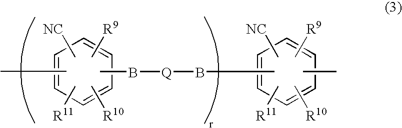
wherein B is independently an oxygen atom or a sulfur atom; R⁹ to R¹¹, which may be the same or different, are a hydrogen atom, a fluorine atom, a nitrile group or an alkyl group; r is 0 or a positive integer; and Q is a structure represented by the following formula (q): 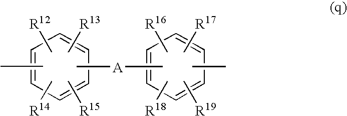
wherein A is a divalent atom, a divalent organic group or a direct bond; R¹² to R¹⁹, which may be the same or different, are a hydrogen atom, a fluorine atom, an alkyl group or an aromatic group.
